(19) United States
(12) Patent Application Publication
(10) Pub. No.: US 2023/0106778 A1
(43) Pub. Date: Apr. 6, 2023

(54) Quantization for Neural Networks

(71) Applicant: HUAWEI TECHNOLOGIES CO., LTD., Shenzhen (CN)

(72) Inventors: Alexander Alexandrovich Karabutov, Moscow (CN); Robert A. Cohen, Burnaby (CA); Hyomin Choi, Burnaby (CA); Saeed Ranjbar Alvar, Burnaby (CA); Ivan Bajic, Burnaby (CA); Elena Alexandrovna Alshina, Munich (DE); Sergey Yurievich Ikonin, Moscow (RU); Maxim Borisovitch Sychev, Moscow (RU)

(73) Assignee: HUAWEI TECHNOLOGIES CO., LTD., Shenzhen (CN)

(21) Appl. No.: 18/074,333

(22) Filed: Dec. 2, 2022

Related U.S. Application Data
(63) Continuation of application No. PCT/RU2021/050105, filed on Apr. 21, 2021.

(30) Foreign Application Priority Data
Jun. 5, 2020 (EP) PCT/EP2020/065604

(51) Int. Cl. G06N 3/0495

(52) U.S. Cl. CPC G06N 3/0495

(57) ABSTRACT

The present disclosure relates to methods and apparatuses for modifying a quantizer. In particular, within a preliminary set of quantization levels, at least one quantization level is modified based on optimization involving distortion for a predetermined set of input values. At least one another quantization level out of the preliminary set is not modified. The not modified (non-modifiable) quantization level is the minimum clipping value or the maximum clipping value. The modification may facilitate increasing the dynamic range of the quantized/inverse-quantized data. Such modified quantizer may be advantageous for employment in neural networks to compress their data such as feature maps or the like. It may improve accuracy of the neural network.

### CROSS-REFERENCE TO RELATED APPLICATIONS

This application is a continuation of International Application No. PCT/RU2021/050105, filed on Apr. 21, 2021, which claims priority to International Application No. PCT/EP2020/065604, filed on Jun. 5, 2020. The disclosures of the aforementioned applications are hereby incorporated by reference in their entireties.

### TECHNICAL FIELD

Embodiments of the present disclosure generally relate to the field of quantization. In particular, some embodiments relate to quantization for use in the framework of artificial intelligence and especially neural networks.

### BACKGROUND

Collaborative intelligence has been one of several new paradigms for efficient deployment of deep neural networks across the mobile-cloud infrastructure. By dividing the network, e.g. between a (mobile) device and the cloud, it is possible to distribute the computational workload such that the overall energy and/or latency of the system is minimized. In general, distributing the computational workload allows resource-limited devices to be used in a neural network deployment. A neural network usually comprises two or more layers. A feature map is an output of a layer. In a neural network that is split between devices, e.g. between a device and a cloud, a feature map at the output of the place of splitting (e.g. a first device) is compressed and transmitted to the remaining layers of the neural network (e.g. to a second device).

Transmission resources are typically limited so that compression of the transferred data may be desirable. In general, compression may be lossless (e.g. entropy coding) or lossy (e.g. applying quantization). The lossy compression typically provides a higher compression ratio. However, it is in general irreversible, i.e. some information may be irrecoverably lost. On the other hand, the quality of compression can have a significant impact on the accuracy of the actual task solved by the neural network. Moreover, minimizing the complexity of the compression process may be of great importance given that mobile devices also have limitations on energy consumption and hardware resources.

### SUMMARY

The present invention relates to methods and apparatuses for compressing data used in a neural network. Such data may include but is not limited to features (e.g. feature maps).

The invention is defined by the scope of independent claims. Some of the advantageous embodiments are provided in the dependent claims.

In particular, some embodiments of the present disclosure relate to modification of quantization levels of a quantizer to increase the dynamic range of the reconstructed values. This approach may provide for better performance in applications such as neural networks, e.g. in terms of accuracy.

According to an aspect, a method is provided for modifying quantization levels of a quantizer for a neural network, the method comprising the steps of: obtaining data values and preliminary quantization levels attributed to the data values, the preliminary quantization levels including at least one non-modifiable quantization level and at least one modifiable quantization level; and determining modified quantization levels to include: the at least one non-modifiable quantization level; and at least one level obtained by adjusting the at least one modifiable quantization level based on a cost function indicative of a distortion between the obtained data values and the preliminary quantization levels, wherein the at least one non-modifiable quantization level includes a minimum clipping value to which all lower data values are clipped and/or a maximum clipping value to which all higher data values are clipped.

Provision of a non-modifiable quantization level, and in particular one corresponding to minimum clipping value or maximum clipping value, may lead to a higher dynamic range. The higher dynamic range may improve the performance of the neural network, e.g. the performance in terms of accuracy.

For example, there are at least two non-modifiable quantization levels, namely at least the minimum clipping value and the maximum clipping value.

Provision of both minimum clipping value and the maximum clipping value as quantization levels increases the dynamic range even further.

In addition or alternatively, there are at least two non-modifiable quantization levels, wherein among the at least two non-modifiable quantization levels, one has the value of zero.

Provision of further quantization levels may be meaningful for further calculations/their simplification of the network.

In an exemplary implementation, the method further includes computing a level as a predefined function of the data values assigned to the level. This enables adaption on the training data.

For example, the predefined function is an average of the data values assigned to said level.

Average facilitates simple computation and fair representation of the data values.

In an embodiment, the cost function includes a linear combination of the distortion and a rate, the rate is represented by codeword length of codewords representing the respective preliminary quantization levels, and the codewords representing at least two respective preliminary quantization levels have mutually different lengths.

Considering variable length coding jointly with distortion during optimization (rather than fixing VLC or designing it separately based on fixed codeword assignment) may lead to a higher accuracy of the neural network and coding efficiency. Moreover, by using known codeword lengths instead of computing probabilities, it isn't necessary to generate an entropy-coded bit stream to compute the rate for the purposes of this computation—the codeword sizes can be simply summed.

In particular, the method may further comprise determining decision thresholds between pairs of adjacent modified quantization levels, wherein a threshold between two adjacent modified quantization levels is determined based on the two adjacent modified quantization levels and based on the codeword lengths representing the respective two adjacent modified quantization levels.

Thresholds determined based on both distortion and rate can lead to more accuracy for the neural network.

The method as mentioned above may be performed iteratively. The steps of obtaining the preliminary quantization levels and determining the modified quantization levels are iterated K times, K being larger than 1, a j-th iteration out of the K iterations comprises: obtaining the preliminary quantization levels corresponding to the modified quantization levels determined by the (j−1)-th iteration, determining the modified quantization levels to include the at least one non-modifiable quantization level and by modifying the at least one modifiable quantization level obtained by the (j−1)-the iteration based on the cost function. By iterating, a higher accuracy can be achieved.

According to an embodiment, the iterative method includes stopping the iterations after the number of iterations K, when: the value of the cost function in the K-th iteration is lower than a first threshold, and/or the difference between the value of the cost function in the (K−1)-th iteration and the value of the cost function in the K-th iteration is lower than a second threshold. By setting number of iteration, accuracy and complexity can be efficiently controlled.

In some implementations, the preliminary quantization levels before the first iteration are obtained as uniform quantization levels. In particular, they may correspond to a uniform linear quantizer. Simple initial guess may provide a good basis for improvement, without substantially increasing the complexity.

For example, the data values are: values of a feature map output by a layer of the neural network, and/or weights of a layer of the neural network. As mentioned above, accuracy of the neural network may be improved by increasing dynamic range, especially for a low number of quantization levels (e.g. around 8 or below). The slight increase of the quantization error does not pose problems for the application in neural networks.

In any of the foregoing embodiments and examples, the method can further comprise the steps of: computing an adjustment distance between the modified quantization levels and the quantization levels before the modification, and adjusting the modified quantization levels by, for each modified quantization level, adopting either said modified quantization level or the quantization level before the modification, depending on the adjustment distance.

According to an aspect, a method is provided for encoding data for a neural network into a bitstream, the method comprising: a step of generating data values by at least one layer of the neural network; the method for modifying quantization levels of a quantizer for the neural network according to any above mentioned embodiments/examples based on predetermined data values and/or the generated data values as the obtained data values; a step of quantizing the generated data values to the modified quantization levels; and a step of including codewords representing the quantized data into the bitstream.

The method may further comprise the step of including an indication of the modified quantization levels into the bitstream. With this embodiment, the decoder need not have pre-stored quantization levels.

According to an aspect, a method is provided for decoding data for a neural network from a bitstream encoded as described above, the method comprising: obtaining, from the bitstream, the indication of the modified quantization levels, obtaining, from the codewords of the bitstream, the data for the neural network based on the obtained modified quantization levels, and processing the obtained data for the neural network by at least one layer of the neural network.

The deployment of the quantization levels with higher dynamic range is beneficial for the further processing by the neural network, as explained above.

According to an aspect, a method is provided for decoding data for a neural network from a bitstream, the method including: obtaining original quantization levels with which the data were quantized; obtaining one or more supplementary quantization levels corresponding to respectively one or more of the original quantization levels, computing an adjustment distance between the original quantization levels and the corresponding supplementary quantization levels, determining modified quantization levels by, for each modified quantization level, adopting either an original quantization level or the corresponding supplementary quantization level, depending on the adjustment distance, obtaining, from the codewords of the bitstream, the data for the neural network based on the obtained modified quantization levels, and processing the obtained data for the neural network by at least one layer of the neural network.

Such approach enables for decoder-side dynamic range increase, even if the encoder device works with any kind of quantizer.

In the method, for example, the one or more supplementary quantization levels include at least one of a minimum clipping value to which all lower data values are clipped, a maximum clipping value to which all higher data values are clipped, zero level.

In addition or alternatively, the adjustment distance includes difference between the original and the corresponding supplementary quantization levels and an offset by a predetermined constant. Distance and offset can be implemented without much increase of the complexity.

In an exemplary embodiment, the determining of the modified quantization levels includes the following steps performed for each of the original quantization levels: calculating the adjustment distance between said original quantization level and between a supplementary quantization level associated with the original quantization level; setting a modified quantization level corresponding to said original quantization level to the supplementary quantization level, when the adjustment distance is smaller than an adjustment threshold, and setting a modified quantization level to said original quantization level otherwise. By such thresholding, smaller adjustments are preferred, which may keep the quantization error limited.

For example, at least one of: the predetermined constant, the adjustment threshold, or the supplementary levels are decoded form the bitstream. This enables coordination and control between the encoder and the decoder as well as setting of these parameters e.g. with the knowledge of source data.

According to an aspect, a computer product is provided comprising a program code for performing the method mentioned above. The computer product may be provided on a non-transitory medium and include instructions which when executed on one or more processors perform the steps of the method (one of the methods mentioned above).

According to an aspect, a quantizer modification device is provided for modifying quantization levels of a quantizer for a neural network, the quantizer device implemented by circuitry configured to perform steps according to any of the methods mentioned above.

According to an embodiment, an encoder is provided for encoding data for a neural network into a bitstream, the encoder comprising: neural network circuitry configured to generate data values by at least one layer of the neural network; the quantizer modification device as described above for modifying quantization levels of a quantizer for a neural network based on predetermined data values and/or the generated data values as the obtained data values; a quantizer configured to quantize the generated data values to the modified quantization levels; and a bitstream generator configured to include codewords representing the quantized data into the bitstream.

According to an aspect, a decoder is provided for decoding data for a neural network from a bitstream, the decoder comprising: quantization adjustment circuitry configured to obtain original quantization levels with which the data were quantized; obtain one or more supplementary quantization levels corresponding to respective one or more of the original quantization levels; compute an adjustment distance between the original quantization levels and the corresponding supplementary quantization levels; and determine modified quantization levels by, for each modified quantization level, adopting either an original quantization level or the corresponding supplementary quantization level, depending on the adjustment distance, inverse quantizer configured to obtain, from codewords of the bitstream, the data for the neural network based on the obtained modified quantization levels, and neural network circuitry configured to process the obtained data for the neural network by at least one layer of the neural network.

According to an aspect, a system for processing data by a neural network, the system comprising: the encoder as mentioned above for encoding data for a neural network into a bitstream; a decoder device including circuitry configured to obtain, from the bitstream, the indication of the modified quantization levels; obtain, from codewords of the bitstream, the data for the neural network based on the obtained modified quantization levels, and process the obtained data for the neural network by at least one layer of the neural network. As mentioned above, application in distributed computing by neural networks may be particularly advantageous thanks to the dynamic range increase of the quantized data.

According to an aspect, the decoder device is implemented by a cloud. Neural networks may be rather complex, so that efficient quantization may enable for a good tradeoff between the rate necessary for transmission and the neural network accuracy.

The above mentioned apparatuses may be embodied on an integrated chip.

Any of the above mentioned embodiments and exemplary implementations may be combined.

### BRIEF DESCRIPTION OF THE DRAWINGS

In the following embodiments of the invention are described in more detail with reference to the attached figures and drawings, in which

FIG. 1 is a schematic drawing illustrating a quantizer Q and an exemplary relation between the quantizer input and output;

FIG. 2 is a flow chart illustrating an exemplary quantization method;

FIG. 3 is a flow chart illustrating an exemplary quantizer determination (design) method;

FIG. 4 is a block diagram illustrating a collaborative system with an edge device and a compute device;

FIG. 5 is a flow chart illustrating a modified quantizer design applying predefined clipping, as well as methods for decoder applying the modified quantization and inverse quantization;

FIG. 6 is a flow chart illustrating an exemplary modified quantization adjustment process;

FIG. 7 is a flow chart illustrating an exemplary quantizer adjustment for decoder;

FIG. 8 is a block diagram showing an example of a video coding system configured to implement embodiments of the invention;

FIG. 9 is a block diagram showing another example of a video coding system configured to implement embodiments of the invention;

FIG. 10 is a block diagram illustrating an example of an encoding apparatus or a decoding apparatus; and

FIG. 11 is a block diagram illustrating another example of an encoding apparatus or a decoding apparatus.

### DESCRIPTION

In the following description, reference is made to the accompanying figures, which form part of the disclosure, and which show, by way of illustration, specific aspects of embodiments of the invention or specific aspects in which embodiments of the present invention may be used. It is understood that embodiments of the invention may be used in other aspects and comprise structural or logical changes not depicted in the figures. The following detailed description, therefore, is not to be taken in a limiting sense, and the scope of the present invention is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

Some embodiments aim at providing a low-complexity compression of data for neural networks. For example, the data may include feature maps, or other data used in neural networks such as weights or other parameters. In some exemplary implementations, compression is provided which may be capable of quantization to a small number of quantization levels (such as three, four, or the like), while maintaining the overall accuracy of the (possibly already-trained) neural network. Some embodiments may also handle the problem of reduced neural network accuracy caused when (inverse) quantizers designed using existing methods reconstruct some feature map values suboptimally. According to a collaborative intelligence paradigm, mobile or edge device may have a feedback from the cloud, if it is needed. However, it is noted that the present disclosure is not limited to the framework of collaborative networks including cloud. It may be employed in any distributed neural network system. Moreover, it may be employed for storing feature maps also in neural networks, which are not necessarily distributed.

In the following, an overview over some of the used technical terms is provided.

A neural network has typically at least one input layer and at least one output layer. In one layer of a neural network there may be one or more neural network nodes, each of which computes an activation function based on one or more of inputs to the activation function. Typically, the activation function is non-linear. A deep neural network (DNN) is a neural network, which has one or more hidden layers. A feature map is an output of a layer (input, output or hidden layer) of neural network. A feature map may include one or more features. Feature map value is a value of an element of a feature map, wherein a feature map can comprise multiple elements (features). Activations are feature map values output by activation functions of a neural network. It is noted that feature maps can also be the outputs of other parts (or functions or processes) of a neural network layer, such as convolution or batch-normalization, or further possible operations. Collaborative intelligence is a paradigm where processing of a neural network is distributed between two or more different computation nodes; for example devices, but in general, any functionally defined nodes. Here, the term “node” does not refer to the above-mentioned neural network nodes. Rather the (computation) nodes here refer to (physically or at least logically) separate devices/modules which implement parts of the neural network. Such devices may be different servers, different end user devices, a mixture of servers and/or user devices and/or cloud and/or processor or the like. In other words, the computation nodes may be considered as nodes belonging to the same neural network and communicating with each other to convey coded data within/for the neural network. For example, in order to be able to perform complex computations, one or more layers may be executed on a first device and one or more layers may be executed in another device. However, the distribution may also be finer and a single layer may be executed on a plurality of devices. In this disclosure, the term “plurality” refers to two or more. In some existing solution, a part of a neural network functionality is executed in a device (user device or edge device or the like) or a plurality of such devices and then the output (feature map) is passed to a cloud. A cloud is a collection of processing or computing systems that are located outside the device, which is operating the part of the neural network.

In some embodiments, a quantization is provided which may be advantageous for passing the neural network data to/within the (possibly distributed) network. Quantization is performed by a quantizer. The term quantizer may refer to an actual device (processing device) or circuitry for performing the quantization. However, the term quantized may be also used to denote a functional (logical) module performing the quantization, which may be implemented in any hardware or software infrastructure.

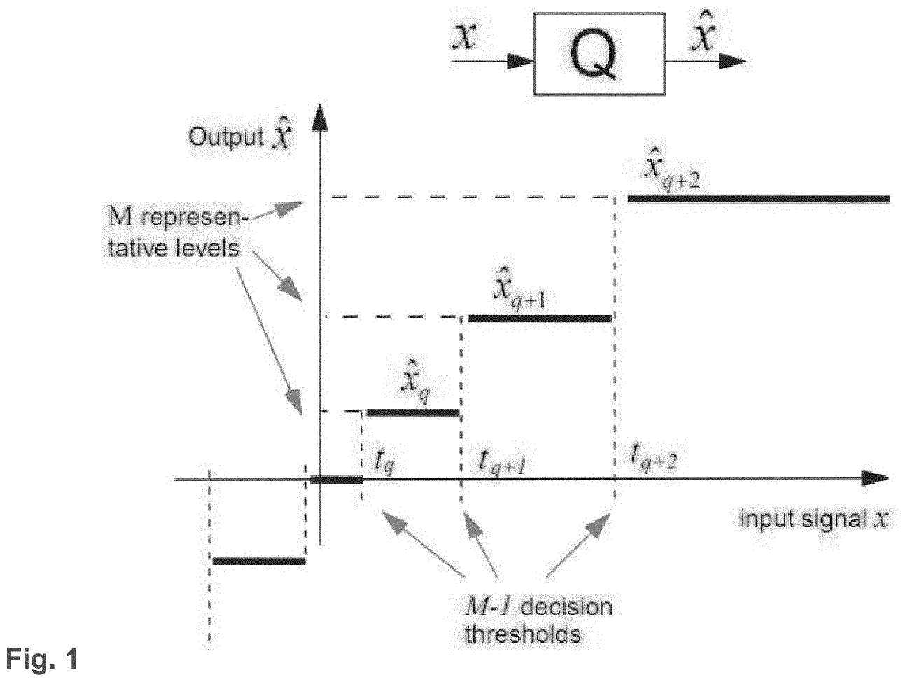

FIG. 1 illustrates a quantizer Q with an input value x and an output value \hat{x}. A quantizer can be seen as a non-linear function which for an input x outputs value of a corresponding quantization level \hat{x}. Quantization levels are a set of values by one of which an input of the quantizer is approximated. In other words, the output of the quantizer for a certain input is the corresponding quantization level. For an input, the corresponding quantization level is determined based on a predefined rule. For example, for an input value, the output is that quantization level which is closest to the input value. However, quantizers may have other rules (e.g. using decision thresholds which do not necessarily lay in the middle between two quantization levels) and various different metrics of distance. The output of the quantizer is the quantized input value, which may be represented by a quantization index. Quantization index is a value or symbol to which quantization level is uniquely mapped. In other words, the quantization levels are one to one (respectively) associated with quantization indexes. The quantization index may be used to transmit (code) the output, quantized values.

An exemplary association between the input values x and an output values \hat{x} is shown in the exemplary graph diagram of FIG. 1. FIG. 1 shows M (here, M is 5) possible quantization levels (output values), among which quantization levels \hat{x}_{q}, \hat{x}_{q+1}, and \hat{x}_{q+2} are included. Any input value is mapped to one of the M quantization levels. The mapping in this example is given by M−1 decision thresholds including t_{q}, t_{q+1}, t_{q+2}. In particular, any input value x which is between the threshold values t_{q+1}, t_{q+2} is quantized to the quantization level \hat{x}_{q+1}. In other words, there are M quantization levels and M−1 decision thresholds, each located between two adjacent quantization levels. Thus, each input value which falls into an interval between two values of adjacent quantization levels is quantized to one of the two adjacent quantization levels according to the threshold laying between the two adjacent quantization levels. In particular, when the input value is smaller than the threshold, the lower of the two adjacent quantization levels is taken and otherwise, the higher of the two adjacent quantization levels is taken as the quantized value.

In order to enable such assignment between the input values and quantized values, it is typically assumed that the input values have some finite input value range. The value range of the quantized (output) values is given by the smallest and the largest value among the quantization levels, i.e. between the lowest and the highest quantization levels.

In order to provide a finite (limited) value range for the input values, the input values prior to quantization may be clipped. Then, quantization levels may be selected based on minimizing a quantizer distortion metric. For example, quantizer distortion metric may be minimum square error between the input values and the respective quantized input values (i.e. output values), or any other distortion metric, or in general a cost function including a distortion term.

The selection of the quantization levels according to a certain quantizer distortion metric yields quantization levels that are interior to thresholds that partition the range of input values into quantizer bins. The term “quantizer bin” refers to an interval between the two adjacent thresholds (t_{q+1}, t_{q+2}) which belong to the quantization level (\hat{x}_{q+1}), i.e. it is an interval from which all values map on said quantization level. The bin may then be represented e.g. by a number (e.g. an index) or by a binary symbol.

The quantized input values may be transmitted or stored and then further used by the neural network (e.g. by the following layers). The process of recovering values out of the quantization indexes or binary symbols is referred to as reconstruction or inverse quantization. Correspondingly, given an index (or binary symbol), the reconstructed value corresponds to the quantization level associated with the index (or the binary symbol). It is notes that in some quantizers, scaling and/or offset is applied before mapping onto the quantization levels. Correspondingly, in such cases, the reconstructed value would be obtained by applying the inverse operation including inverse offset and scaling back.

For example level \hat{x}_{q+1} may be represented by (uniquely associated with) an index 3. Index three may be coded as a bin “11”. It is possible to directly associate the levels with binary symbols, without providing index. In the description herein, when reference is made to indexes, it is understood that the indexes may be replaces directly by binary symbols, and vice versa. Binary symbols may be binary words (codewords) which have the same (fixed length) or which have variable length (corresponding, e.g. to entropy coding). The association between the quantization levels and indexes or quantization levels and binary symbols is unique and predefined.

When quantizing clipped input values to a very small number of quantization levels, known quantizers typically cause the neural network to lose some accuracy, because the available reconstructed values are greater than the minimum clipping value or are less than the maximum clipping value; or because a subset of feature map values to be quantized do not have corresponding equal (or substantially close) quantization levels. Some techniques arrange feature map values to form an image and then conventional image compression techniques are applied. The disadvantage of those techniques is that they can consume significant power and hardware resources on a device, and they can exhibit poor compression efficiency when applied to the arranged feature map values.

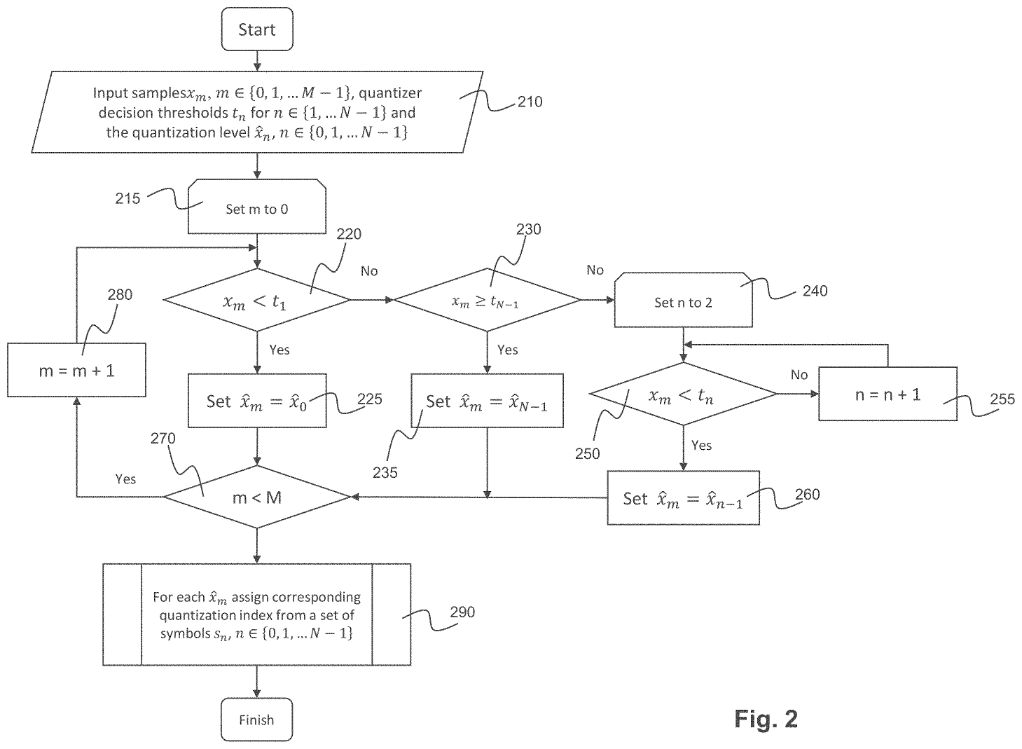

An example of a known quantization process, which implements a quantizer, is shown in FIG. 2. In step 210, the quantizer is given a sequence of input values xₘ, m∈{0, 1, . . . M−1}. The quantizer is defined by quantization levels \hat{x}ₙ, n∈{0, 1, . . . N−1} and by quantization decision thresholds tₙ, n∈{1, . . . N−1}. Before starting the quantization of the input values xₘ, m∈{0, 1, . . . M−1}, in step 215, m is initialized (set) to zero. With each value of m (m is incremented in step 280), one of the input values is quantized. In particular, after initialization 215, in each step m, the quantizer compares the respective m-th value xₘ to a set of quantizer decision thresholds tₙ, n∈{1, . . . N−1} and maps each xₘ to the quantization level \hat{x}ₙ, n∈{0, 1, . . . N−1}corresponding to the smallest value of (n−1) for which x<tₙ, n∈{1, . . . N−1} and corresponding to (N−1) if x is not less than any tₙ. Thus, the set of real numbers [symbol] ¹ is partitioned into N quantizer bins, where the quantizer decision thresholds are the boundaries of the bins, and each bin includes a quantization level \hat{x}ₙ to which any xₘ that falls within the associated bin is mapped. Each bin is assigned a quantization index from a set of symbols sₙ, n∈{0, 1, . . . N−1}, and when an input value xₘ is mapped to quantization level xₙ, the quantization process outputs symbol sₙ. The symbols used for a quantization index can be integers, e.g. sₙ=n, n∈{0, 1, . . . N−1}, corresponding to the index of the quantizer bin.

In particular, when looking at FIG. 1, in step 220 it is tested whether the input value xₘ is smaller than the smallest threshold value t₁. If affirmative, the xₘ input value is quantized to the minimum quantization level xo in step 225. If, on the other hand, in step 220 the input value xₘ is not smaller than the smallest threshold value t₁, in step 230 it is tested whether the input value xₘ is larger than or equal to the largest threshold value t_{N-1}. If affirmative, the xₘ input value is quantized to the maximum quantization level \hat{x}_{N-1} in step 235. If not affirmative in step 230, a loop over n∈{1, . . . N−1} is initialized with n set to two in step 240. In the loop, for each n, it is tested in step 250, whether the xₘ input value is smaller than n-th decision threshold tₙ. If affirmative, in step 260, the xₘ input value is quantized to the corresponding quantization level \hat{x}ₙ₋₁. Otherwise, the next iteration is performed by increasing n by one in step 255. After performing one of the steps 225, 235, and 260, the xₘ input value is quantized to one of the possible quantization levels \hat{x}ₙ, n∈{0, 1, . . . N−1}.

Then in step 270, if there is another input value to be quantized, the method increases m (which corresponds to picking the other input value for quantizing) and performs the steps starting from 220 and ending with one of the steps 225, 235, and 260. After all input values xₘ, m∈{0, 1, . . . M−1} are quantized, in step 290, the quantized values are assigned the corresponding symbol sₙ. There is a unique association between the quantizer bins (represented by the respective quantizer levels) and symbols sₙ. Symbols sₙ may be indexes or symbols of any kind, e.g. fixed or variable-length binary codewords.

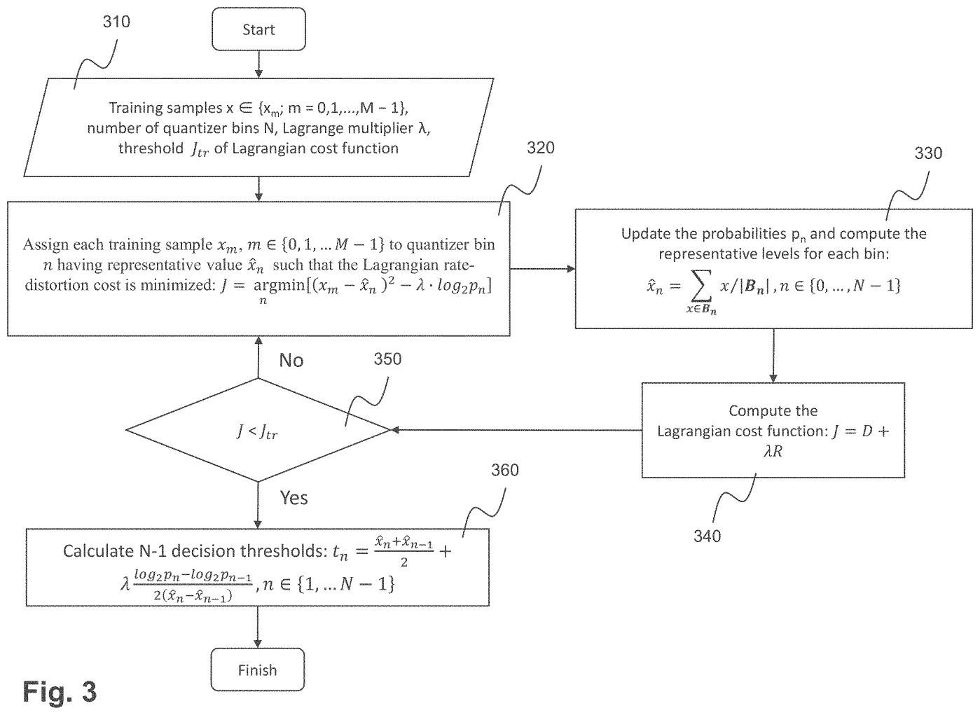

An exemplary entropy-constrained scalar quantizer design process is shown in FIG. 3. The term “quantizer design” refers to deriving quantization levels \hat{x}ₙ, n∈{0, 1, . . . N−1} and quantizer decision thresholds tₙ, n∈{1, . . . N−1}. In general, one of simplest quantizers is a uniform quantizer, which divides the value range of the input valued into bins of the same size. However, such quantizer is only efficient, if the input values are uniformly distributed within the value range. Otherwise, other approaches may provide better results. In order to design better quantizers, the distribution of the data is taken into account. In particular, a quantizer may be designed by optimizing the quantization levels and/or thresholds for a certain set of training data. It is noted that the term “set of training data” here does not refer to training of neural networks. Rather, the training data here refers to a set of input values which are taken to optimize the quantizer in order to minimize certain cost function. This may be, for instance a distortion function such as mean square error, i.e. mean of quantization error between the input value and its corresponding quantized input value (output of the quantizer). However, any other distortion measure may be used, or, more generally, any other cost function which may include (in addition or alternatively to the distortion) further terms such as rate or complexity, or the like. It is noted that the training set may be the set used only for training and then the quantizer design based on this training set is applied to other data. Or, the training set may correspond to the data which are then quantized by the quantizer and the quantizer parameters may be indicated to the peer that performs the inverse quantization. Some hybrid solutions are possible, which apply re-training, meaning that the quantizer design is regularly performed to adapt the quantizer to the input data which may have changing characteristics (distribution).

For example, the quantizer design in FIG. 3 is based on a cost function including Lagrangian multiplier to weight contribution of rate against contribution of distortion in the cost function. In other words, the quantizer design of FIG. 3 is a rate-distortion based quantizer design.

The design of the quantizer comprises the following steps in order to output quantization levels \hat{x}ₙ, n∈{0, 1, . . . N−1} and quantizer decision thresholds tₙ, n∈{1, . . . N−1}. At first, in step 310, the data and parameters for quantizer design are obtained. In particular, the training input values (samples) xₘ, m∈{0, 1, . . . M−1} are obtained. This may be done, e.g. by reading them from a storage or by sampling an analogue signal or in any other way. Then, parameters of the quantizer design are obtained. These may include number of quantizer bins N. The lower the N, the coarser becomes the quantization, i.e. the higher is the achievable minimum quantization error, the higher is the compression of the input data. Another quantizer design parameter may be the Lagrange multiplier λ and the threshold Jₜᵣ of the Lagrangian cost function. These parameters may be selected by a user or by the application using the quantizer designed by this method. In general, the parameters are predefined in any manner.

After obtaining the training data and the quantizer design parameters, the method is initialized before performing step 320, which may be performed iteratively:
1. Initialize the quantization levels \hat{x}ₙ and probabilities pₙ for each quantizer bin, for n∈{0, 1, . . . N−1} (e.g., uniform and equi-probable).
   In the initialization, a uniform scalar quantizer is derived based on the quantizer design parameter, number N of desired bins. Herein, the probability pₙ is a probability that an input value (training sample) falls into the n-th bin. In this exemplary initialization step, the bins have the same size and the probabilities pₙ are the same.
2. Step 320: Assign each training sample xₘ, m∈{0, 1, . . . M−1} to quantizer bin n having quantization level \hat{x}ₙ such that the Lagrangian rate-distortion cost J is minimized:

$$J = {arg min}_{n} [ {( {x}_{m} - {\hat{x}}_{n} )}^{2} - λ \cdot {log}_{2} {p}_{n} ]$$

The subset of samples xₘ assigned, in this way, to bin n is denoted as Bₙ.
3. Step 330: Update the probabilities pₙ based on the assignment from Step 2, and re-compute the quantization levels for each bin:

$${\hat{x}}_{n} = {\sum }_{x ∈ {B}_{n}} x / \vert {B}_{n} \vert , n ∈ \{ 0 , … , N - 1 \}$$

where |Bₙ| is the number of training samples assigned to bin n.
The updating of the probabilities may be performed by estimating the probability for each bin by dividing the number of samples assigned to this bin by the total number of samples. As can be seen from the above formula, the n-th quantization level corresponds to mean value of the training samples assigned to the corresponding n-th bin.
4. Step 340: Based on the re-computed quantization levels, re-compute the Lagrangian cost function (specified in step 2), and repeat Steps 2 and 3 until the reduction in the cost function j is less than the threshold Jₜᵣ. The threshold is tested in Step 350.
   It is noted that in FIG. 3, the cost Function J=D+λR is written in a shortened form in which D represents distortion corresponding to the square error (xₘ−\hat{x}ₙ)² and R represents rate corresponding to the term log₂pₙ in the cost function of Step 2.
5. Step 360: Compute N−1 quantizer decision thresholds:

$${t}_{n} = \frac{{\hat{x}}_{n} + {\hat{x}}_{n - 1}}{2} + λ \cdot \frac{{log}_{2} {p}_{n} - {log}_{2} {p}_{n - 1}}{2 ( {\hat{x}}_{n} - {\hat{x}}_{n - 1} )} , n ∈ \{ 1 , … N - 1 \} .$$

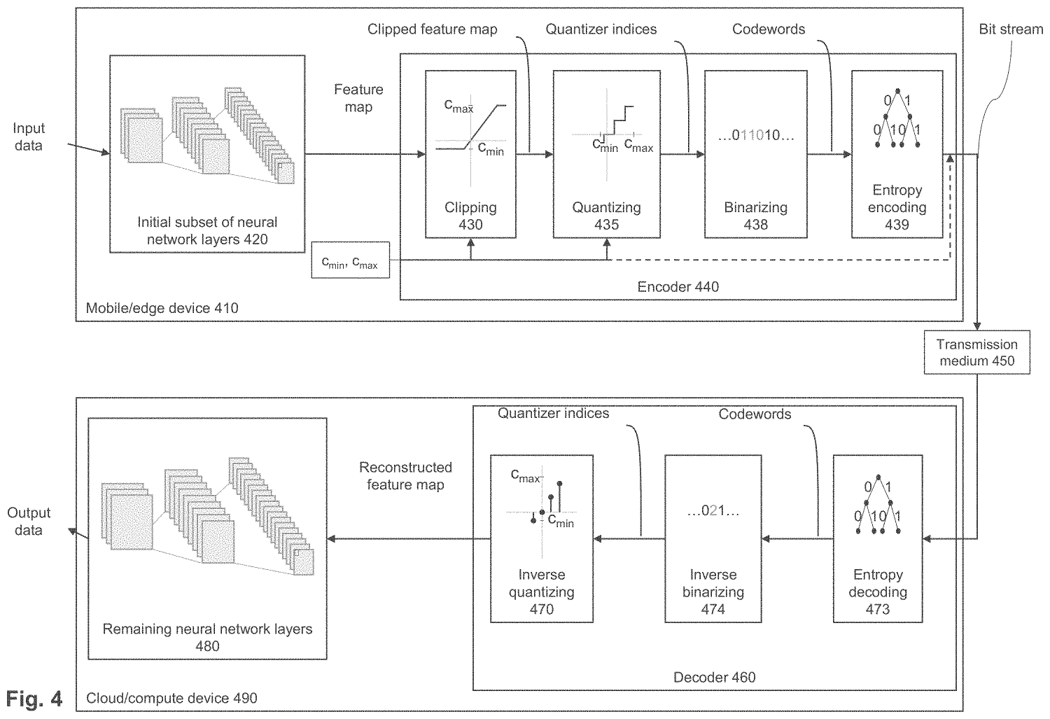

This quantizer design may be beneficial for general data and for larger number N of quantization levels. However, it may exhibit some shortcomings especially in the context of compressing feature maps in neural networks, in particular when the compression is supposed to be high. FIG. 4 illustrates application of a compression method in a collaborative intelligence application. The collaborative intelligence involves (at least) two entities (systems): an edge device 410 and a compute device 490. In this example, the edge device 410 may be a mobile user device. In general, the edge device 410 has less computation power than the compute device 490. In order to perform more computationally complex tasks, the edge device performs only a part of the task and transmits the intermediate result to the compute device over a transmission medium 450.

The edge device 410 may include a first number of neural network layers 420 which process input data to generate a feature map. The feature map is then encoded with an encoder 440 also belonging to the edge device 410.

The neural network may be a DNN. Layers in a DNN may include operations such as convolutions, batch normalization operations, and activation functions. The output of a layer is a feature map. If the first subset of layers of a DNN 420 are performed for example on a mobile or edge device 410, it would be useful to compress the feature map output by this first subset 420 for transmission 450 to the platform 490 that is performing the remaining layers 480 of the DNN. Because the compression will be performed in an encoder 440 on an edge device 410, it is advantageous to keep the complexity of the compression method relatively low, while not significantly compromising the accuracy of the DNN model. For a “lightweight compression” provided by the present disclosure, it is relied on relatively simple operations such as clipping 430 and very coarse scalar quantization 435 to a few quantization levels. To further compress the data, quantized symbols are transformed 438 to a binarized representation for passing to an entropy coder 439. In summary, the edge device 410 comprises one or more neural network layers 420 and an encoder 440. The encoder includes circuitry implementing a clipping module 430, quantizer 435, binarization 438, and entropy coding 439.

The compressed bitstream is sent to the cloud 490 or another computing platform, where it is decoded by a decoder 460 and converted to a reconstructed feature map, which is then processed by the remaining layers of the DNN 480. The net effect of this process on the DNN computations is that the output of one layer is clipped and quantized; namely the layer that will be transmitted. The decoder 460 of the compute device 490 includes entropy decoder 473, inverse binarization 474 and inverse quantization 470.

The feature map values at the encoder 440 are clipped (clamped) 430 to be between predetermined minimum and maximum values cₘᵢₙ and cₘₐₓ. Clipped feature map values can then be quantized 435 using a uniform, e.g. a linear quantizer, or a nonlinear quantizer. When a linear quantizer is used, a clipped feature map value, denoted as x_{clp}, is processed by an N-level quantizer to generate a quantized index or symbol Q(x_{clp}) as follows:

Q(x_{clp})=round((x_{clp}−cₘᵢₙ)/(cₘₐₓ−cₘᵢₙ)·(N−1)),

where the operation round(⋅) rounds away from zero for halfway cases (rounds to the closest value). Unlike in known architectures that focuses on reduced bit-depth architectures, the number of quantization levels (bins) N does not need to be a power of two, as the purpose of quantization is for compression and subsequent transmission or storage in a bit-stream. Thus, N here is not necessarily the number of bits to which the clipped feature map value is quantized, nor is N constrained to be an integer power of 2; it is the number of levels or symbols to which a value is quantized, and the number of integer bits that corresponds to an N-level quantizer is ┌log₂N┐, but through entropy coding, the average number of bits needed to represent a feature map value can be a non-integer value less than ┌log₂N┐.

Although a uniform quantizer is simple, it is not optimal for signals that are not uniformly distributed, as already mentioned above. Moreover, because there is a trade-off between DNN accuracy and bit-rate when compressing feature maps, it would be desirable to compress them over a range of rates or file sizes. Entropy-constrained quantization (such as the one described with reference to FIG. 3) and rate-distortion optimization are methods for compressing data subject to minimizing the above-mentioned Lagrangian cost function:

J=D+λR,

where D is a distortion metric, R is a rate or size of representation, and λ is a scalar, which determines the ratio between distortion and rate during the computation of the distortion metric. Thus, optimal quantizers can be easily obtained as shown above in the mean-squared (l²-norm) sense over a range of rates by using the entropy-constrained design process. However, the accuracy of a DNN is quite sensitive to the clipping range of a layer's feature map values when quantized to a very low number of levels, e.g. fewer than 8 levels. The quantization level for each bin of such l²-norm optimized quantizer corresponds to the centroid of the data quantized to that bin. Due to the non-symmetric distribution of the feature map values, the reconstructed data may span a range much smaller than the initial clipping range, because the smallest reconstructed value will be greater than cₘᵢₙ, and the largest reconstructed value will be less than cₘₐₓ. Therefore, the range spanned by the reconstructed feature map values will be less than the range spanned by the clipped feature map values prior to quantization. In this situation, the remaining layers of the DNN will be operating on data whose dynamic range is less than that of the unquantized feature map, which can degrade the overall accuracy of the DNN.

To address this problem, embodiments of the present disclosure include a modified entropy-constrained quantizer design process to pin the quantization levels of the outermost quantizer bins to cₘᵢₙ and/or cₘₐₓ. This is to ensure that the reconstructed feature map values span the full clipping range.

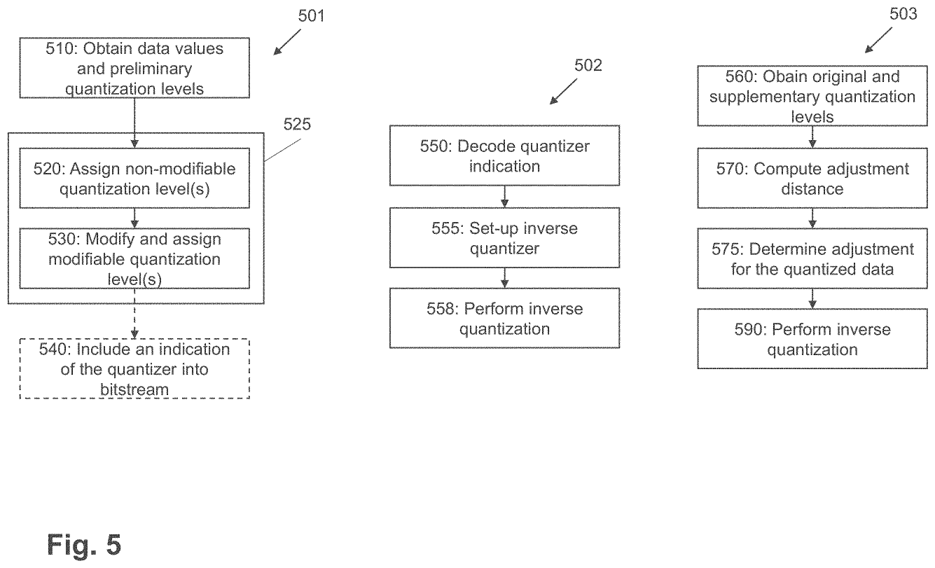

In particular, according to an embodiment, a method is provided for modifying quantization levels of a quantizer for a neural network. Modifying quantization levels means modifying a set of the quantization levels of a quantizer. This refers to adjusting at least one of the quantization levels. The method 501 is illustrated in FIG. 5. The method comprises the step of obtaining 510 data values and preliminary quantization levels attributed to the data values. The preliminary quantization levels include at least one non-modifiable quantization level and at least one modifiable quantization level. It is noted that the data values may be for example a training set, e.g. training samples. The obtaining may be implemented as reading from a memory/storage or receiving from another device such as a sensor or analog to digital converter, or the like. The attributing of the data values to the quantization levels may be performed, e.g. based on the decision thresholds defined between the quantization levels. In general, such attribution may be performed according to a predefined rule.

The method further comprises a step of determining 525 modified quantization levels to include: the at least one non-modifiable quantization level (assigned to the modified quantization levels in step 520); and at least one level obtained by adjusting the at least one modifiable quantization level. The adjustment 530 is based on a cost function indicative of a distortion between the obtained data values and the preliminary quantization levels. The at least one non-modifiable quantization level includes a minimum clipping value to which all lower data values are clipped and/or a maximum clipping value to which all higher data values are clipped.

One of the advantages of such modified quantizer design is provision of a higher dynamic range. It has been found by the inventors that in neural networks a higher dynamic range may actually increase network accuracy despite possibly increased quantization error. Thus, the above-described modified quantizer may provide particular advantages when used for compressing data in a neural network.

It may be even more advantageous, if there are at least two non-modifiable quantization levels and these two levels are the minimum clipping value and the maximum clipping value. This enables to further increase the dynamic range.

However, it is noted that the present disclosure is not limited to non-modifiable levels being the minimum level and the maximum level. In addition, or alternatively to one of the minimum and maximum level, a non-modifiable level may be the level with the value of zero. Provision of zero level may be meaningful for further calculations and/or their simplification of the neural network. In addition, or alternatively, other quantizer levels may be non-modifiable.

Providing non-modifiable quantization levels is what is referred to herein as “pinning” those quantization levels. This means that these quantization levels are pinned (fixed) at a predefined value and not modified during the adjustment of the quantizer to the data values (e.g. training data values). As mentioned, in some embodiments, this pinning can be applied to other reconstructed feature map values (as well), not (just) minimum and maximum values. In case the outer—minimum and maximum—quantization levels are pinned, the quantization levels for the interior bins and the threshold values between all bins are not pinned and are free to vary under the quantizer design algorithm. In general, there is one or more pinned (also referred to herein as non-modifiable or fixed) quantization levels and one or more modifiable quantization levels which may vary under the quantizer design operation (also referred to as not pinned or non-fixed).

To design quantizers that work well in a lightweight compression system for neural networks using clipped feature map values, the modified quantizer design process may be adapted as is shown in the following exemplary embodiment. In this exemplary embodiment, the non-modifiable values are the clipping values.

The modified quantizer design in this embodiment differs from the quantizer design described with reference to FIG. 3 in particular in hat steps include the pinning of the first and last quantization levels in the following step 4, and the use of codeword lengths instead of entropy for calculating/computing the rate term in step 6 (and, correspondingly in step 3). It is noted that in some embodiments, only the following step 4 (pinning the non-modifiable levels) may be different from that of FIG. 3. The remaining cost function computation as well as the threshold calculation may be performed in the same way as in FIG. 3 or in another way.

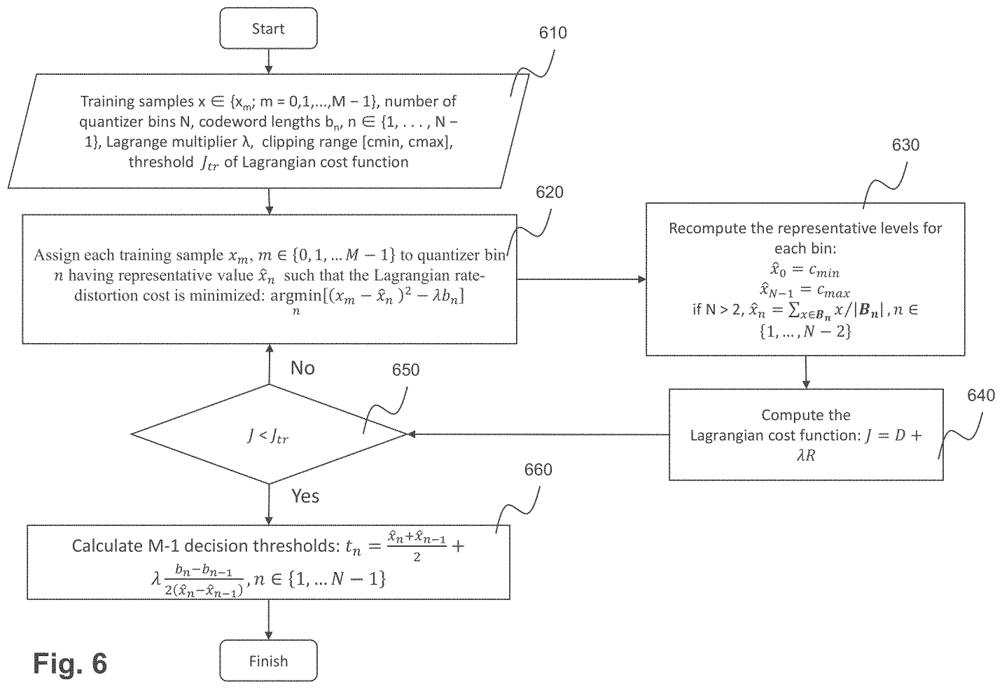

A modified quantizer method is illustrated in the flowchart of FIG. 6. In step 610, the (training) input data x∈{xₘ; m=0, 1, . . . , M−1} is obtained. Moreover, the parameters used in the quantizer design are obtained such as the desired number of bins N, codeword lengths bₙ, n∈{1, . . . , N−1}, Lagrange multiplier λ, clipping range [cₘᵢₙ, cₘₐₓ], and the threshold Jₜᵣ of Lagrangian cost function. These parameters may be all pre-set or one of more of the parameters may be configurable by a user or by an application or by another device implementing one or more layers (e.g. cloud device), or the like. In general, the way of obtaining these parameters is not limiting the present disclosure. After obtaining the input data values and the parameters, the modified quantization starts with initializing. The following steps are performed:
1. Clip (clamp) the training feature map values (input values) x to be within [cₘᵢₙ, cₘₐₓ], which is the clipping range applied to the feature map values.
   As mentioned already with regard to the quantization design of FIG. 3, the term “training” here does not refer to neural network training, but rather to a set of values for which the quantizer is optimally designed. The term “optimally” herein refers to an optimum corresponding to a minimum of a certain predefined cost function.
2. Initialize the quantization levels \hat{x}ₙ for each quantizer bin, for n∈{0, 1, . . . N−1} (e.g., the quantizer levels are initialized to the levels of a uniform quantizer as described above for the quantizer design of FIG. 3).
   It is noted that this is only an example and that, in general, the quantizer may be initialized to another value. In particular, the quantizer may be some quantizer optimized for values of a certain distribution, or trained for another data set, or the like.
3. Step 620: Assign each training sample xₘ, m∈{0, 1, . . . M−1} to quantizer bin n having quantization level \hat{x}ₙ such that the Lagrangian rate-distortion cost is minimized:

$${arg min}_{n} [ {( {x}_{m} - {\hat{x}}_{n} )}^{2} - λ {b}_{n} ]$$

The subset of samples xₘ assigned to bin n is denoted as Bₙ, and bₙ is the codeword length, in bits, output by the quantizer for bin n. In this example, the binary codewords assigned to each bin are variable-length codes, corresponding to entropy coding 439.
Thus, in this particular example, the cost function employs the same distortion term (square norm of quantization error), but a different rate term than the quantizer design of FIG. 3. However, it is noted that this is only an exemplary embodiments and that, in general, the rate term does not have to be present at all or the same rate term involving the probabilities as in FIG. 3 may be used, or another rate term may be used. In addition or alternatively, other terms may be used, such as complexity or the like.
4. Step 630: Re-compute the quantization level for each bin:

$${\hat{x}}_{0} = {c}_{min}$$

$${\hat{x}}_{N - 1} = {c}_{max}$$

$$if N > 2 : {\hat{x}}_{n} = {\sum }_{x ∈ {B}_{n}} x / \vert {B}_{n} \vert , n ∈ \{ 1 , … , N - 2 \}$$

Where |Bₙ| is the number of samples assigned to bin n.
As can be seen, step 630 differs from step 330 described above by pinning the highest and the lowest quantization levels to cₘᵢₙ, cₘₐₓ respectively. In other words, in this example, the minimum and the maximum quantization levels \hat{x}₀ and \hat{x}_{N-1} are non-modifiable quantization levels. The remaining quantization levels of the quantizer in this example are modifiable quantization levels, and are re-computed as shown above for n larger than zero and smaller than N−1, i.e. for n∈{1, . . . , N−2}.
5. Step 640: Based on the re-computed quantization levels, re-compute the Lagrangian cost function, and repeat steps 3 and 4 until the reduction in the cost function J is less than a threshold Jₜᵣ (tested in step 650). This steps corresponds to steps 340 and 350, but step 650 here uses the modified cost function mentioned in step 3 above and employing the codeword lengths to represent rate.
   It is noted that the iteration stopping criteria applied in steps 650 and 350 (based on a threshold on improvement by an additional iteration) are only exemplary. Such criterion has the advantage that the number of iterations is adapted to the speed of convergence. Other terminating criteria may be used. For example, the iteration may stop after a predetermined (pre-set) number of iterations. Such criteria may be advantageous in case the complexity needs to be kept low/limited. Further criteria are possible.
6. Step 660: Compute N−1 quantizer decision thresholds:

$${t}_{n} = \frac{{\hat{x}}_{n} + {\hat{x}}_{n - 1}}{2} + λ \frac{{b}_{n} - {b}_{n - 1}}{2 ( {\hat{x}}_{n} - {\hat{x}}_{n - 1} )} , n ∈ \{ 1 , … N - 1 \}$$

Step 660 differs from step 360 by its adaption to the different cost function. As can be seen, in this example, the first term (\hat{x}ₙ+\hat{x}ₙ₋₁)/2 corresponds to an average value between the two quantization levels. This decision threshold is modified by a second term indicative of difference (bₙ−bₙ₋₁) between the rate (codeword length) associated with the respective quantization levels \hat{x}ₙ and \hat{x}ₙ₋₁. This term is divided by the difference (\hat{x}ₙ−\hat{x}ₙ₋₁) between the pair of the quantization levels adjacent to the threshold to and weighted by the Lagrange multiplier and by ½.

The modified quantizer may lead to a more accurate neural network operation than the quantizer designed as shown in FIG. 3. This is mainly caused by the fact that, especially for low number N of quantization levels (such as 8 or less), the peak accuracy of the actual task solved by the neural network, for example the peak minimum average precision (mAP), and the minimum mean square quantization error (MSQR) are not both achieved when using the same set of maximum and/or minimum clipping values. In other words, the minimum/maximum clipping values that minimize MSQR become different from the clipping values that optimize mAP.

In the following, an example is provided which illustrates, why pinning the outer quantization levels to cₘᵢₙ and cₘₐₓ is needed. Suppose for the sake of an example that a one-bit quantizer divides value interval [0.0, 2.0] into two bins, [0.0, 1.0) and [1.0, 2.0], and the quantizer levels for these two bins are 0.3 and 1.5, respectively. If feature map values are clipped to [0.0, 2.0], quantized, and transmitted, then the receiver's inverse quantizer would output reconstructed feature maps having only the values 0.3 or 1.5, making the dynamic range of the feature map values to be within the interval [0.3, 1.5]. This is much smaller than the initial clipped value range of [0.0, 2.0].

To address this problem, the modified entropy-constrained quantizer design process as described with reference to FIG. 6 is to pin the reconstruction levels of the outermost bins to cₘᵢₙ and cₘₐₓ, in order to ensure that the reconstructed activations span the full clipping range. (At least some of) the reconstruction values for the interior bins and the threshold values between bins are not pinned and are free to vary under the design algorithm. The above-example has been shown for only two quantization levels for the sake of simplicity. However the behavior resulting in reduction of the dynamic range may be dominant also for a higher number of quantization levels, which also enable modification of one or more (modifiable) quantization levels.

It is noted that FIG. 6 is detailed example, possibly including a plurality of iterations. However, the present disclosure may improve an initial quantizer already upon performing one modification step, as was described with reference to FIG. 5.

In general, the method of FIG. 5 may further include a step of computing a quantization level as a predefined function of the data values assigned to the level. The predefined function may be an average of the data values assigned to said level. The average provides for simple computation, at the same time as for a fair representation of the data values. However, there are alternatives which may be used instead of the average, such as a weighted average, median, or any other function.

In some embodiments, the cost function includes a linear combination of the distortion and a rate. The rate is represented by codeword length of codewords representing the respective preliminary quantization levels, and the codewords representing at least two respective preliminary quantization levels have mutually different lengths. This corresponds to the example described with reference to FIG. 6 above. One of the advantages of such approach is considering the variable length coding jointly with distortion during optimization (rather than fixing VLC or designing it separately based on fixed-codeword assignment). Such approach may lead to a higher accuracy of the neural network as well as facilitate achieving higher coding efficiency. Another possible advantage is that by using known codeword lengths instead of computing probabilities, it is not necessary to generate an entropy-coded bit stream to compute the rate for the purposes of this computation—the codeword sizes can be simply summed.

However, it is possible to apply different cost function. For example, cost function including (indicative of) distortion and complexity may be applied, or other cost functions as already mentioned above. The codewords may have fixed length so that rate does not need to be considered or may be considered in another form.

It is further noted that it may be advantageous to provide, for some feature maps, a 1-bit quantization, for which there are two codewords which are “0” and “1” and thus both have a length of one bit. In such case, if there are two non-modifiable quantization levels, those levels are the final levels, so that no modification is necessary. However, there may be one modifiable and one non-modifiable quantization level. If there is only one non-modifiable quantization level, then for the one-bit quantization case, the other level may be determined based on a cost function without considering the codeword length.

The method may further include a step of determining decision thresholds between pairs of adjacent modified quantization levels, wherein a threshold between two adjacent modified quantization levels is determined based on the two adjacent modified quantization levels and based on the codeword lengths representing the respective two adjacent modified quantization levels. An example for such determination of the decision thresholds can be seen in step 360 and 660. However, the present disclosure is not limited to determining the threshold in such way. In principle, the threshold may be determined to be located in the middle of the bin calculated as average between the two adjacent modified (including modifiable and, possibly, non-modifiable) quantization levels. The average may be weighted or otherwise modified. The thresholds may also be calculated in a different way.

For the sake of better explanation, it is referred herein to modifiable quantization levels and to non-modifiable quantization levels. Both kinds of levels form part of modified quantization levels of the quantizer, which may be referred to as a set of quantization levels of the quantizer. In general, modifiable quantization levels are levels of a first type which may be modified during the quantizer design by applying some kind of optimization. Non-modifiable quantization levels are levels of a second type which are not modifiable (i.e. are pinned) during the quantizer design.

As can be seen in the example of FIG. 6, the above mentioned method may be performed iteratively. According to an embodiment based on FIG. 5, the steps of obtaining 510 the preliminary quantization levels and determining 525 the modified quantization levels are iterated K times, K being larger than 1. A j-th iteration out of the K iterations comprises: (i) obtaining 510 the preliminary quantization levels corresponding to the modified quantization levels determined by the (j−1)-th iteration, and (ii) determining 525 the modified quantization levels to include the at least one non-modifiable quantization level and by modifying the at least one modifiable quantization level obtained by the (j−1)-the iteration based on the cost function.

By iterating, a higher accuracy can be achieved. By setting/limiting a number of iterations, accuracy and complexity can be controlled.

Before the first iteration, the preliminary quantization levels are obtained as uniform quantization levels, in some exemplary implementations. However, the present disclosure is not limited to such initialization. In general, even better performance may be achieved by initializing the quantizer to a quantizer designed for data distributed in a more similar manner to the training data. Thus, it is possible to regularly update the quantizer design for different training data, in which case, the initial quantizer may correspond to the last designed quantizer. Nevertheless, starting from a uniform quantizer may provide a simple initial guess and good basis for improvement.

The iterative approach may include a step of stopping the iterations after the number of iterations K, when: at least one of the following two criteria applies: (i) the value of the cost function in the K-th iteration is lower than a first threshold, (ii) the difference between the value of the cost function in the (K−1)-th iteration and the value of the cost function in the K-th iteration is lower than a second threshold. Embodiments are possible, in which only criterion (i) is used or in which only criterion (ii) is used (e.g. steps 350, 650). Such criteria (rules) depend on quality and/or contribution of the current iteration to the improvement, which enables adaption of the method to achieve desired quality/complexity.

It may be advantageous to judge whether or not the adjustment of a (modifiable) quantization level is to be performed. According to an exemplary embodiment, which may be based on any of the above-mentioned embodiments and exemplary implementations, the method further comprises the step of computing an adjustment distance between the modified quantization levels and the respective corresponding quantization levels before the modification. This may be performed in each iteration or after terminating the iterations, or after some predetermined number of iterations. Then the method may include a step of adjusting the modified quantization levels by, for each modified modifiable quantization level, adopting either said modified quantization level or the quantization level before the modification, depending on the adjustment distance.

For example, the adjustment distance calculated between the modified and the original quantization level may be compared to a threshold and if the distance is less than the threshold, the modification is adopted; otherwise the modification is not adopted. The “adopting” herein refers to generating adjusted quantization levels which include: (i) the non-modifiable quantization levels (ii) for each modifiable quantization level either the preliminary (or initial) quantization level or the modified quantization level, depending on the adjustment distance.

The quantizer design described herein may facilitate efficient operation of a distributed neural network. For example, in an embodiments the method for designing a quantizer is applied to data of the neural network. In one embodiment, the data values are: (i) values of a feature map output by a layer of the neural network, and/or (ii) weights of a layer of the neural network. However, the present disclosure is not limited to these kinds of data for neural networks. Further data and parameters may be encoded in this way. It is possible to also apply the quantization for the data generated by training of the neural network, including the above-mentioned feature maps and weights as in case of the neural network operation. In addition or alternatively, the learning data in the backward direction within the neural network may be coded/quantized by the modified quantizer design. The method may works well for quantizing feature maps of a neural network after the neural network has already been trained, i.e. post-training quantization. In other words, no re-training (of the weights) of the neural network is needed. However, there is no limitation to such approaches and, in general the methods described herein may be also used with re-training.

As is shown in FIG. 4, a method for encoding data for a neural network into a bitstream, the method comprising: a step of generating data values by at least one layer 420 of the neural network (with layers 420 and 480). The method then applies modifying quantization levels of the quantizer 435 in accordance with any of the above-described examples, based on predetermined (training) data values and/or the generated data values as the obtained data values. In other words, the modified quantizer may be designed based on the data which is actually to be encoded with the quantizer or based on some other predetermined (training) data. The predetermination here may be performed in any way. The training data may be taken from some representative source, read from a storage, or obtained from another device, or the like. The method may further include a step of quantizing 435 the generated data values to the modified quantization levels, and a step of including 438, 439 codewords representing the quantized data into the bitstream.

Herein, the term bitstream refers to a bitstream which may be used for transmission 450 and/or storing or buffering, or the like. Before the transmission, the bitstream may undergo further packetization including coding and modulation and possibly further transmitter operations, depending on the medium over which the encoded data is transmitted. The predetermined data here refers to the training data which is used in quantizer design. It is not data for training the neural network, but rather data to the statistics of which, the quantizer is adapted (designed). The quantization 435 can reduce the amount of data that needs to be signaled to a bit-stream in order to achieve the purpose of the system (such as neural network processing). A further reduction may be achieved by applying the entropy coding 439. The length of the codewords may be designed jointly with quantizer design, or separately.

According to an embodiment (compatible with any of the above-mentioned embodiments), the method further comprises the step of including 540 an indication of the modified quantization levels into the bitstream. This is illustrated in FIG. 5 as a step performed after the quantizer is designed in steps 510-530.

Including an indication into the bitstream may be advantageous as it enables updating of the quantizer for specific input data, e.g. encoded in the bitstream. The decoder need not have a pre-stored quantizer. It is noted that the indication may indicate directly the entire quantizer, e.g. by transmitting the quantization levels and/or other parameters that enable deriving the inverse quantizer at the decoder side.

FIG. 4 illustrates the lightweight compression system when used with a neural network in the collaborative intelligence application. The input to the system is input data, which can be an image, video, or other numerical representations of data. The neural network comprises layers 420, 480 that implement operations such as convolutions, batch normalization operations, and activation functions. The neural network is split so that the initial subset 420 of layers is performed on a device 410 such as a mobile or edge device, and the remaining layers 480 are performed on a different device such as cloud or computing device or platform 490. The last layer in the initial subset 420 of layers outputs a feature map comprising feature map values. The feature map values are input to a clipping process 430 in which each value is clipped to be within [cₘᵢₙ, cₘₐₓ], i.e. feature map values less than cₘᵢₙ are adjusted to be equal to cₘᵢₙ, and feature map values greater than cₘₐₓ are adjusted to be equal to cₘₐₓ. The clipping process outputs a clipped feature map comprising clipped feature map values, which are subsequently input to a quantizing process 435. The quantizing process, which includes a quantizer and can also include scaling and offset operations, maps each clipped feature map value to a quantization level, and outputs a quantizer index associated with each mapped quantization level. This may be performed in accordance with the example described with reference to FIG. 2.

The quantizer can include parameters created by the modified entropy-constrained scalar quantizer design process of FIG. 5 or 6. The quantizer indexes output by the quantization process 435 are input to a binarization process 438, which maps each input quantizer index to a codeword comprising a string (sequence) of bits (one or more bits). The sequence of codewords is compressed to a bit stream via an entropy encoding process 439. The bitstream can be stored in a file or signaled over a transmission medium 450 to another platform such as the cloud computing device 490 that performs the remaining layers 480 of the neural network. Upon receiving the bit stream, an entropy decoding process 473 decodes the bit stream and outputs the sequence of codewords. The codewords are input to an inverse binarizing process 474 which performs the inverse of the mapping performed in the binarizing process in order to output quantizer indices. The sequence of quantizer indices are passed through an inverse quantizing process 470 comprising an inverse quantizer and can also include an inverse scaling and/or offset operation, which in total performs the reverse of the quantizing process mapping, to output quantizer levels or scaled and offset quantizer levels that represent the reconstructed feature map.

The reconstructed feature map is input to the remaining layers 480 of the neural network, which in turn produces output data according to the purpose of the neural network. This output can include data such as a classification index, object-detection coordinates and metadata, pixel segmentation data, reconstructed images and video, time-series predictions, and other data predictions. Parts or all of the output data can be signaled back to the device performing the first subset of neural network layers or to other devices. The modified quantization may be also applied to encode these data.

The clipping process 430 of FIG. 4 clips or clamps its input values to be contained in the range [cₘᵢₙ, cₘₐₓ]. Given an input value x_{nonclip}, which can be a feature map value, the clipping process outputs a value x_{clp} according to the following method:

$${x}_{clp} = \{ \begin{matrix}{c}_{min} : if {x}_{nonclip} < {c}_{min} \\ {c}_{max} : if {x}_{nonclip} > {c}_{max} \\ {x}_{nonclip} : otherwise\end{matrix}$$

The values cₘᵢₙ and cₘₐₓ can be predetermined and stored in, and retrieved from memory, or they can be input to either the mobile/edge device 410 or cloud/compute device 490 as parameters, or they can be signaled in the bit stream. One way to predetermine the clipping values cₘᵢₙ and cₘₐₓ are to run the neural network offline while applying different clipping values at the output of the first subset of neural network layers and measuring how close the output of the remaining neural network layers is to a known reference output, and then choosing the clipping values that minimize the difference between the output data and the known reference output data, i.e. maximize the accuracy of the neural network output. The clipping values may be estimated according to a predetermined algorithm or obtained in any other way.

The quantizing process 435, which includes a quantizer, is shown in FIG. 2. Given an input value x, the quantizer compares it to a set of quantizer decision thresholds tₙ, n∈{1, . . . N−1} and maps x to the quantization level \hat{x}ₙ, n∈{0, 1, . . . N−1} corresponding to the smallest value of (n−1) for which x<tₙ, n∈{1, . . . N−1} and corresponding to (N−1) if x is not less than any tₙ. Thus, the set of real numbers [symbol] ¹ is partitioned into quantizer bins, where the quantizer decision thresholds are the boundaries of the bins, and each bin includes a quantization level to which any x that falls within a given bin is mapped. Each bin is assigned a quantization index from a set of symbols sₙ, n∈{0, 1, . . . N−1}, and when an input value x is mapped to quantization level \hat{x}ₙ, the quantization process outputs symbol sₙ. The symbols used for a quantization index can be integers, e.g. sₙ=n, n∈{0, 1, . . . N−1}, corresponding to the index of the quantizer bin. The quantizer decision thresholds and quantization levels can be computed prior to operation of the quantization process, including using the modified entropy-constrained scalar quantizer design process of FIG. 5 or FIG. 6.

The quantizing process 435 can also include offset and scaling operations. For a value x_{clp} input to the quantization process, an offset can be added to x_{clp} and that sum can be scaled, so that the values processed by the quantizer are within a known range of values. If the offset value is −cₘᵢₙ and the scaling value is 1/(cₘₐₓ−cₘᵢₙ), then (x_{clp}−cₘᵢₙ)/(cₘₐₓ−cₘᵢₙ) is input to the quantizer. Given that x_{clp} has already been processed so that it is within [cₘᵢₙ, cₘₐₓ], the offset and scaled values input to the quantizer will be within [0.0, 1.0].

The binarizing process 438 maps a quantizer index to a codeword. A truncated unary binarization scheme is one example of this mapping. For a quantizer having four quantizer levels, the quantizer indices {0,1,2,3} could be mapped to the binary codeword strings {0, 10, 110, 111} respectively. For a given quantizer index input to the binarizing process, the corresponding codeword is output.

The entropy encoding process 439 compresses a sequence of codewords and outputs a bit stream. An example of an entropy encoder is context-adaptive binary arithmetic coding (CABAC), for which one context can be assigned to each bit position of the binary codeword strings. If the set of codewords were {0, 10, 110, 111}, then three contexts can be used, as the codewords can be up to three bits long. Fewer contexts can be used as well, such as one context for all bit positions. However, the present disclosure is not limited to CABAC. Any other kind of entropy coding may be applied, such as context-adaptive variable length-coding (CAVLC), or even entropy codes without context adaption may be applied.

The bit stream, which can be stored in memory, further processed by a computer, or signaled over a transmission medium 450 is retrieved or received and is input to an entropy decoding process 473, which inverts the process performed by the entropy encoder. The codewords output by the entropy decoder are identical to the codewords input to the entropy encoder, i.e. the entropy encoding and decoding processes are lossless.

The entropy-decoded codewords are input to an inverse binarizing process 474, which outputs quantizer indices by inverting the mapping specified in the binarizing process. The quantizer indices output by the inverse binarizing process are identical to the quantizer indices input to the binarizing process 438.

The quantizer indices are then input to the inverse quantizing process 470, which outputs a quantization level corresponding to the input quantization index. In this embodiment, the quantizer decision thresholds and quantization levels used in the inverse quantizing process are identical to those used in the quantizing process. They may be signaled, set up fixedly, or partially signaled/partially derived from data available at the encoder and the decoder.

If the quantizing process 435 includes scaling and offset operations and if in the quantizing process the offset value is −cₘᵢₙ and the scaling value is 1/(cₘₐₓ−cₘᵢₙ), then the quantization level in the inverse quantizing process 470 is multiplied by (cₘₐₓ−cₘᵢₙ) and then cₘᵢₙ is added, so that when the quantizer in the quantizing process outputs a quantization level \hat{x}ₙ, a reconstructed clipped value \hat{x}_{clp}=\hat{x}ₙ·(cₘₐₓ−cₘᵢₙ)+cₘᵢₙ corresponds to a reconstructed feature map value output by the inverse quantization process.

In this embodiment, the mapping of quantization levels to quantization indices is the inverse of the corresponding mapping in the quantizing process. The quantization levels output by the inverse quantizing process correspond to reconstructed feature map values. The reconstructed feature map values are then input to the remaining neural network layers, which output the final output data generated by the neural network.

In summary, according to an embodiment, a method is provided for decoding data for a neural network from a bitstream encoded by any of the above-mentioned methods. The method is illustrated in FIG. 5. The decoding method 502 comprises the steps of obtaining 550, from the bitstream, the indication of the modified quantization levels. Correspondingly, the inverse quantizer is set 555 at the decoder, meaning that based on the indication, the quantization levels to be used in inverse quantization are derived and set in use. Moreover, the method includes obtaining 558, from the codewords of the bitstream, the data for the neural network based on the obtained modified quantization levels; and processing the obtained data for the neural network by at least one layer of the neural network. This approach may facilitate application to neural network features when the layers of the neural network are not directly connected. Indication of the quantizer enables adaption of the quantizer at both the encoder and the decoder.

The above solution generally applies to the quantizer design process. The quantizer is used both in the encoder and decoder, although in some cases the quantizer may be designed before operation of the neural network. In some cases, the parameters that define how the quantizer works can be signaled in a bit stream to the quantizer as mentioned above (see step 540).

In summary, some embodiments of the present disclosure relate to quantizer design, i.e. to determination of quantizer levels based on a set of predetermined samples to be quantized. The quantizer design may be implemented as a method or may be implemented as a device, e.g. circuitry including the respective modules for performing the steps described above. Moreover, the present disclosure provides an encoder and a decoder which apply the designed quantizer and the corresponding methods, e.g. in a neural network. The neural network may be, for example a neural network for compressing video or audio signals or other kind of signals. However, the present disclosure is not limited thereto and the quantizer may be employed with any neural network, e.g. working as a classifier or the like. The present disclosure provides also an encoder, which implements the quantization design to realize an adaptive quantizer, which may be re-trained for changing input data. The quantizer design, quantization, encoding and decoding may be implemented as a program or as an integrated circuit.

However, the modification of a quantizer which is part of the above quantizer design may also be applied at a decoder. Even though, at the decoder, the quantization design using the training data is typically not performed, it may be advantageous to apply quantizer modification as will be described below.

In this case, the encoder's quantizer can be any known quantizer. The decoder can also contain a known inverse quantizer, possibly inverse to the encoder quantizer. However, the decoder also receives, from the bitstream, a list of fixed supplementary quantization levels. During the inverse quantization in the decoder, a reconstructed value is compared to the fixed (supplementary) quantization levels contained in the list. If a distortion (adjustment) metric between the reconstructed value and fixed (supplementary) quantization level is less than a threshold which can be predetermined, computed, or decoded from the bit stream, then the reconstructed value is adjusted to be equal to the fixed (supplementary) quantization level that minimizes that distortion (adjustment) metric. In conventional video or image compression schemes, one would typically not want the decoder to change the reconstructed values, as there would be a mismatch between the reconstructed values in the encoder and those in the decoder. However, for neural network applications, the ultimate goal is to maximize the output accuracy of the neural network, and due to its nonlinear nature, it may be worthwhile incurring an increase in reconstruction error which may occur due to the adjustment of the quantization levels at the decoder. For example, if the encoder's quantizer does not pin the minimum and/or maximum quantization levels to cₘᵢₙ, and cₘₐₓ, as can happen when the encoder is part of a product that cannot be modified (e.g. belongs to a different party than the decoder), then during decoding, the minimum and maximum quantization levels can still be modified to be equal to cₘᵢₙ, and cₘₐₓ, respectively. Thus, a mismatch is caused between the encoder and decoder, but it is ensured that the decoded reconstructed values span a desired dynamic range, which may be beneficial to the overall performance of the neural network. Additionally, a value λ_{adj} can be decoded from the bit stream so that the decoder can use it in the distortion adjustment metric as will be shown below.

According to an embodiment, a method is provided for decoding data for a neural network from a bitstream. A particular example of the method 503 is shown in FIG. 5. The method includes the step 560 of obtaining original quantization levels with which the data were quantized and obtaining one or more supplementary quantization levels corresponding to respective one or more of the original quantization levels. Here, the correspondence may be given e.g. implicitly by providing as supplementary quantization levels the minim and/or maximum and/or zero level, or by any other predefined convention. Alternatively, the correspondence may be determined by comparing the supplementary quantization levels to the original quantization levels and finding the closest (the most similar one). For example, each original level can be measured against (compared with) every supplementary level. However, this may not be necessary and the comparison may be performed only for a subset of the levels.

The method 503 further includes computing 570 an adjustment distance between the original quantization levels and the corresponding supplementary quantization levels. The adjustment distance may be absolute difference or another distance metric. The method 503 further includes determining 575 modified quantization levels by, for each modified quantization level, adopting either an original quantization level or the corresponding supplementary quantization level, depending on the adjustment distance. In other words, the number of the modified quantization levels may be the same as the number of the original quantization levels and there may be a one-to-one correspondence between the respective modified and original quantization levels. Then, each modified level is set to be the corresponding original level or one of the supplementary quantization levels. In general, the supplementary quantization levels can be a list of one or more extra quantization levels, and then the correspondence is determined based on some optimization using a cost function or simply based on the differences as mentioned above. It is noted that, as is apparent from the above examples, that “correspondence” does not (necessarily) mean the same, it means that there is a relation between pairs of supplementary and original quantization levels. It does not mean that every original quantization level has the corresponding supplementary quantization level. However, it may be that each supplementary has a corresponding original. This is reasonable in order to avoid any permutation in pairing between the original and supplementary quantization levels.

The method 503 further includes obtaining 590, from the codewords of the bitstream, the data for the neural network based on the obtained modified quantization levels. In other words, the inverse quantization (reconstruction) is performed. If the adjustment is performed for providing data to a neural network, the method may further include processing the obtained data for the neural network by at least one layer of the neural network.

If, for example, the supplementary quantization levels are analogous to the minimum and maximum values discussed earlier, then it is possible to restore the dynamic range of the quantized data. Without such restoration, the original quantization levels may not have sufficient dynamic range for satisfactory performance of the rest of the neural network, as explained above with reference to quantizer design.

The term “modified quantization levels” may also be replaced with the term “adjusted quantization levels”, since the modification may be seen as adjustment of the original quantization levels.

In an exemplary implementation, the one or more supplementary quantization levels include at least one of a minimum clipping value to which all lower data values are clipped, a maximum clipping value to which all higher data values are clipped, zero level. One of the advantages of such supplementary levels is that they can restore dynamic range or can restore “important” values (such as zero value or the edge values) to be fed to the rest of the neural network.

For example, the adjustment distance includes (an absolute) difference between the original and the corresponding supplementary quantization levels and, possibly, an offset by a predetermined constant.

In particular, in an embodiment, the determining of the modified quantization levels includes the following steps performed for each of the original quantization levels:
calculating the adjustment distance between said original quantization level and between a supplementary quantization level associated with the original quantization level;
set a modified quantization level corresponding to said original quantization level to the supplementary quantization level, when the adjustment distance is smaller than an adjustment threshold, and
set a modified quantization level to said original quantization level.

It is noted that the supplementary quantization level associated with the original quantization level is obtained by the above mentioned correspondence. For example, it may be obtained by finding the supplementary quantization level with most similar value or least cost for an original quantization level. It is also noted that the sign or direction of the adjustment distance can be considered when comparing to an adjustment threshold. For example, the comparison can also include checking to see if the direction of adjustment is positive or negative, or increasing or decreasing, in order to constrain whether the adjustment increases or decreases the modified quantization level.

In particular, at least one of (or more, or all of): the predetermined constant; the adjustment threshold (for being used in comparison with the adjustment distance to decide whether to adopt the original or the corresponding supplementary quantization level), or at least one supplementary level is decoded form the bitstream.

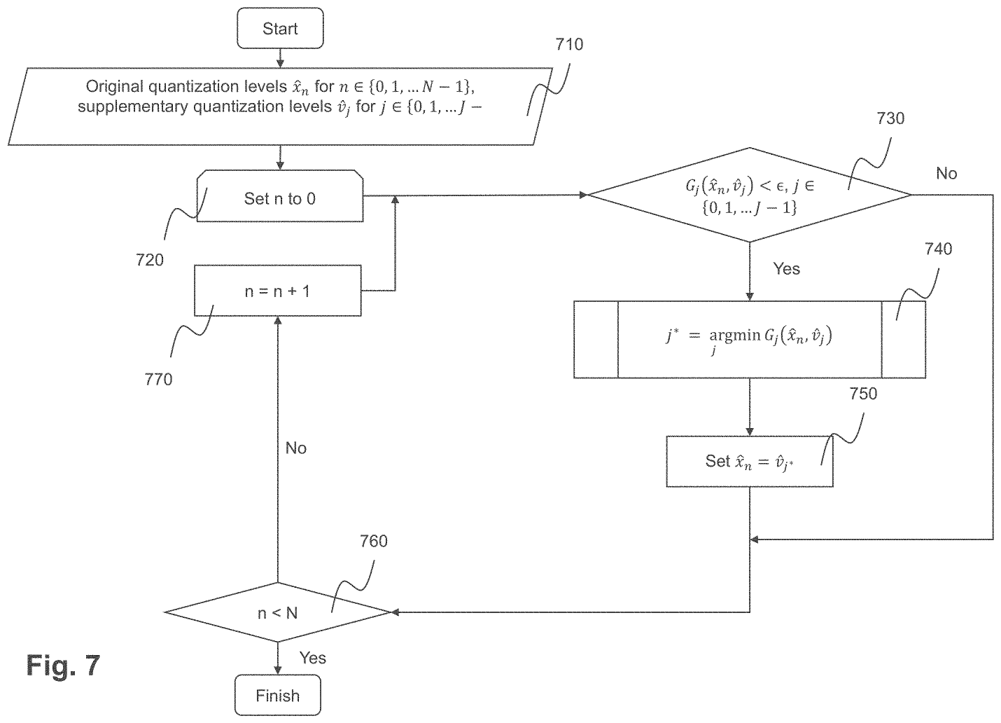

An exemplary decoder-side quantizer modification is illustrated in FIG. 7. Accordingly, the quantization levels in the inverse quantization process are modified to contain two sets of quantization levels. The first set, \hat{x}ₙ, n∈{0, 1, . . . N−1} can be identical to the quantization levels used in the quantization process and the quantization levels in this first set are denoted as the original quantization levels. In the second set, \hat{v}ⱼ, j∈{0, 1, . . . J−1}, the quantization levels are denoted as supplementary quantization levels. As part of the inverse quantization process, quantization indices (extracted from the bitstream) are mapped to quantization levels using a modified mapping (inverse quantization) process. This modified mapping (inverse quantization) process adjusts one or more of the original quantization levels \hat{x}ₙ, n∈{0, 1, . . . N−1} to be equal to a supplementary quantization level contained in the set \hat{v}ⱼ, j∈{, 1, . . . J−1} if an adjustment distance metric G(⋅) between 5, and 17 is less than a threshold E.

The steps in this process are:
1. Step 710: Given is a set of original quantization levels \hat{x}ₙ, n∈{0, 1, . . . N−1} and a set of supplementary quantization levels \hat{v}ⱼ, j∈{0, 1, . . . J−1}. J is the number of the supplementary quantization levels and N is the number of supplementary levels. J and N may be the same. However, in some embodiments J may be smaller than N.
   These sets may be obtained from the bitstream or one of these set (for example, the original set) may be pre-configured, or the like. For example, the original set may correspond to uniform quantization or to a quantization levels obtained by design as shown with reference to FIG. 3 or any other quantizer. Moreover, the threshold ϵ may be obtained in this step, for example from the bitstream or may be set at the decoder by a user or by application or the like. The iteration variable n going over the original quantization levels is initialized to zero: n=0 in step 720.
2. Step 730: Compute a set of adjustment distance metrics Gⱼ(\hat{x}ₙ,\hat{v}ⱼ) for j∈{0, 1, . . . J−1}, with J being the amount of the supplementary levels. The adjustment distance metric may be any distance metric such as difference or the like.
3. Steps 740 and 750: If one or more of the J adjustment distance metric values Gⱼ(\hat{x}ₙ,\hat{v}ⱼ) j∈{0, 1, . . . J−1} are less than the threshold ϵ, then adjust (in step 750) \hat{x}ₙ to be equal to \hat{v}_{j*}, where

$${j}^{*} = {arg}_{j} min {G}_{j} ( {\hat{x}}_{n} , {\hat{v}}_{j} ) ,$$

i.e. \hat{v}_{j*} is the supplementary quantization level that is closest with respect to the distance metric to the \hat{x}ₙ which is obtained in step 740. In other words, in this step, 740, the original quantization levels which come sufficiently close to a j*-th supplementary quantization level are replaced with the supplementary quantization level. Thus, the supplementary quantization level is adopted instead of the original quantization level.
4. In step 770, increment n, and if n≤N−1 in step 760, then go to step 730 (2. step above).
5. The output of this process is an adjusted set of quantization levels \hat{x}ₙ, n∈{0, 1, . . . N−1}, where one or more of the original quantization levels have been adjusted to be equal to a supplementary quantization level.

The distance metric function Gⱼ(\hat{x}ₙ,\hat{v}ⱼ) can include metrics such as P-norm of the distance: Gⱼ(\hat{x}ₙ,\hat{v}ⱼ)=|\hat{x}ₙ−\hat{v}ⱼ|, or a signed difference: Gⱼ(\hat{x}ₙ, \hat{v}ⱼ)=\hat{x}ₙ−\hat{v}ⱼ, or any other metric that is used to measure distance. In the inverse quantization process, the original quantization levels are replaced by the adjusted quantization levels, hence, the quantization indices are mapped to adjusted quantization levels.

In this example, the input values are scalar and the quantizer designed herein is a scalar quantizer. However, the present disclosure is also applicable for vector quantizer design. For example, the feature map comprises elements that can be vectors, and the quantizer is a vector quantizer. Correspondingly, the quantizer levels can be vectors. In the above-mentioned distance metric, then the corresponding vector [symbol] ¹-norm or as [symbol] ²-norm, or any other norm may be applied. The same may be applied for the embodiments regarding quantizer design at the encoder side and the corresponding metrics/cost functions.

It is noted that in the above-mentioned example, it is iterated over n, which is an iteration index of the original quantization levels. However, implementations are possible, in which the iterations are performed over index j for the supplementary levels by searching for the original quantization levels that come close (measured by the adjustment distance metric) to the supplementary levels.

In some exemplary implementations, as mentioned above, the set of supplementary quantization levels is \hat{v}ⱼ, j∈{0,1}, where \hat{v}₀=cₘᵢₙ and \hat{v}₁=cₘₐₓ.

Alternatively or in addition, the distance metric Gⱼ(\hat{x}ₙ,\hat{v}ⱼ) is modified by adding to it λ_{G}·∥sₙ∥, where ∥sₙ∥ is the length in bits of the codeword mapped to the quantization level \hat{x}ₙ. For the case when the [symbol] ¹-norm is used in the distance metric, this embodiment would be equivalent to using a distance metric Gⱼ(\hat{x}ₙ,\hat{v}ⱼ)=|\hat{x}ₙ−\hat{v}ⱼ|+λ_{G}·∥sₙ∥. The weight λ_{G} may be determined empirically by trying out various values (e.g. by performing an optimization to derive the value) or may be obtained from the bitstream and/or set by a user or an application. In one exemplary embodiment, λ_{G} is decoded from the bit stream in which the supplementary quantization levels are indicated.

For example, the set of binary codeword strings (which code the indexes representing quantized data which may take values of the quantization levels) are decoded from the bit stream. The modified inverse quantization adjustment process of FIG. 7 may be used to adjust the quantization levels in the quantizing process, as already mentioned above with reference to encoder embodiments.

If the quantization level adjustment is applied at the decoder, the quantizer in the quantizing process at the encoder can also be a linear or uniform quantizer, which makes it possible for the quantizer to be implemented via a rounding process. In this case, a quantizer represented by the function Q(x_{clp}), which outputs a quantization index, can be implemented using:

Q(x_{clp})=round((x_{clp}−cₘᵢₙ)/(cₘₐₓ−cₘᵢₙ)·(N−1))

where N is the number of quantization levels, and round(⋅) rounds to the nearest integer (in a direction away from zero, meaning that e.g. +3.5 is rounded to 4, and −3.5 is rounded to −4 (not −3). In other words, rounding of halfway values are to the integer with the next largest magnitude (and same sign)).

According to an embodiment, the initial subset of neural network layers is performed on a cloud or computing device or platform 490, and the remaining neural network layers are performed on a mobile or edge device 410. In other words, the present disclosure is not limited to the case in which the edge device includes a quantizer and the cloud includes an inverse quantizer as shown in FIG. 4. Rather, in addition or alternatively, the quantizer may be employed in the cloud and the inverse quantizer may be employed in the edge device. In general, the present disclosure is not limited to edge and cloud devices and the quantization and inverse quantization described herein may be employed in any devices. The same devices may include both quantizer and inverse-quantizer, as they may be capable of both transmitting and receiving compressed data (e.g. data for the neural network).

In any of the above mentioned embodiments and examples, the set of fixed final quantization levels may include cₘᵢₙ and cₘₐₓ. Feature map values may be partitioned into a set of feature tensors, with each tensor comprising a two-dimensional array of r×c feature map values, with r and c being integers. Such feature maps may be readily used for instance in neural networks implementing image or video coding, or some parts of the image or video coding (such as filtering or prediction or the like). It is noted that the term “feature tensor” above refers to a two-dimensional array. However, in general, the feature map and/or the feature tensor may have more (or even less) dimensions, depending on the neural network structure. Thus, the above example is not to limit the present disclosure to any particular size or format of the feature maps or feature tensors.

A set of fixed final quantization levels (modified quantization levels) may be signaled in (or decoded from) the bit stream for each feature tensor. This enables a more precise reconstruction, but requires some signaling overhead. Alternatively, or with a possibility of configuring the granularity of signaling, a set of fixed final quantization levels is signaled in (or decoded from) the bitstream for each feature map (This implementation consumes less bits then previous embodiment, but may result in higher quantization error).

The level on which the set of fixed final quantization levels is signaled (e.g. per feature map or feature tensor or the like) may be configurable, as mentioned above. For example, the level may be signaled selected based on the area r·c of a feature map's tensor and the number of bits nbits that corresponds to an N-level quantizer, according to the following steps: If the number of bits used to signal the fixed final quantization levels is greater than 8·r·c·nbits, then the set of fixed final quantization levels is signaled once per feature map. Otherwise, it is signaled for each tensor in the feature map. However, the present disclosure is not limited to the above approach and there may be more levels of signaling, or other decision mechanism for deciding the level.

As mentioned above, the quantizer levels used in the quantizing process may be signaled in the bit stream, and they may be decoded from the bit stream for use in the inverse quantizing process. They do not necessarily have to be directly used for the inverse quantization and may be modified (adjusted) according to one of the above described embodiments for decoder applying adjustment to some supplementary quantization levels.

Regarding the distance metric applied in some embodiments, one predefined distance metric function may be used. The predefined distance metric function is selected from a set of predefined distance metric functions, and the index of the selected distance metric function can be signaled to (or decoded from) the bit stream once for each feature map (or for other part, depending on the signaling level configured or predefined). For example, a distance metric function may be selected from a set of predefined distance metric functions, and the index of the selected distance metric function is signaled to (or decoded from) the bit stream once for each feature map tensor.

The set of supplementary quantization levels may be predefined (i.e. it is not necessary to signal it in the bitstream). In another embodiment, a plurality of sets of supplementary quantization levels are predefined and an index corresponding to a set is used in the inverse quantization process according to the methods of this invention is signaled to (decoded from) the bit stream once for each feature map. However, it is also possible to have a combined embodiments in which a plurality of sets of supplementary quantization levels are predefined and index corresponding to a set is used in the inverse quantization process according to the methods of this invention is signaled to (decoded from) the bit stream once for every feature tensor.

In a further exemplary implementation, a plurality of sets of supplementary quantization levels are predefined and index corresponding to a set is used in the inverse quantization process according to the methods of this invention is signaled to (decoded from) the bit stream for all feature tensors.

Alternatively, element of the set of supplementary quantization levels may be signaled in a bitstream.

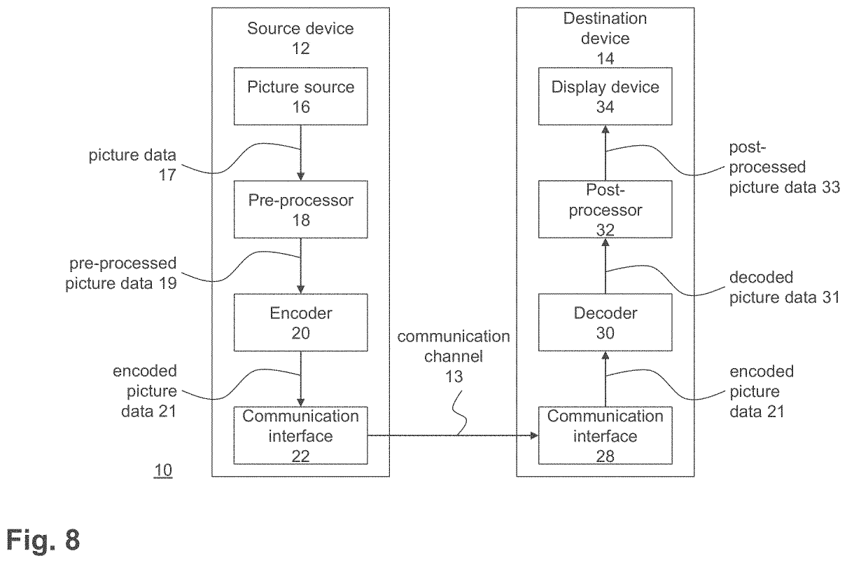

The corresponding system which may deploy the above-mentioned encoder-decoder processing chain is illustrated in FIG. 8. FIG. 8 is a schematic block diagram illustrating an example coding system, e.g. a video, image, audio, and/or other coding system (or short coding system) that may utilize techniques of this present application. Video encoder 20 (or short encoder 20) and video decoder 30 (or short decoder 30) of video coding system 10 represent examples of devices that may be configured to perform techniques in accordance with various examples described in the present application. For example, the video coding and decoding may employ neural network such as the one shown in FIG. 4 which may be distributed and which may apply the above-mentioned quantization and inverse-quantization to convey feature maps between the distributed computation nodes (two or more).

As shown in FIG. 8, the coding system 10 comprises a source device 12 configured to provide encoded picture data 21 e.g. to a destination device 14 for decoding the encoded picture data 13.

The source device 12 comprises an encoder 20, and may additionally, i.e. optionally, comprise a picture source 16, a pre-processor (or pre-processing unit) 18, e.g. a picture pre-processor 18, and a communication interface or communication unit 22.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YCbCr), color correction, or de-noising. It can be understood that the pre-processing unit 18 may be optional component. It is noted that the pre-processing may also employ a neural network (such as in FIG. 4) which uses the quantizer and/or inverse quantizer.

The video encoder 20 is configured to receive the pre-processed picture data 19 and provide encoded picture data 21.

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally, i.e. optionally, comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, communication interface 22 and communication interface 28 may be configured as unidirectional communication interfaces as indicated by the arrow for the communication channel 13 in FIG. 8 pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission. The decoder 30 is configured to receive the encoded picture data 21 and provide decoded picture data 31 or a decoded picture 31 (e.g., employing a neural network based on FIG. 4).

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YCbCr to RGB), color correction, trimming, or re-sampling, or any other processing, e.g. for preparing the decoded picture data 31 for display, e.g. by display device 34.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LCoS), digital light processor (DLP) or any kind of other display.

Although FIG. 8 depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 8 may vary depending on the actual device and application.

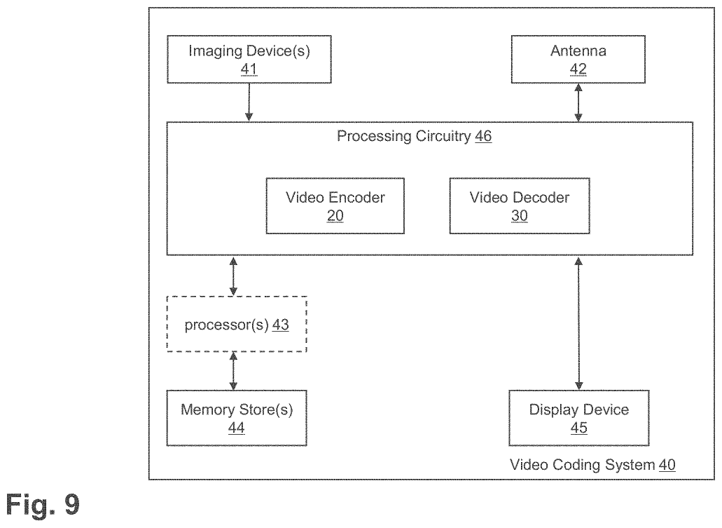

The encoder 20 (e.g. a video encoder 20) or the decoder 30 (e.g. a video decoder 30) or both encoder 20 and decoder 30 may be implemented via processing circuitry as shown in FIG. 16, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules including the neural network such as the one shown in FIG. 4 or its parts. The decoder 30 may be implemented via processing circuitry 46 to embody the various modules as discussed with respect to FIG. 4 and/or any other decoder system or subsystem described herein. The processing circuitry may be configured to perform the various operations as discussed later. If the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 9.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 8 is merely an example and the techniques of the present application may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

For convenience of description, embodiments of the invention are described herein, for example, by reference to High-Efficiency Video Coding (HEVC) or to the reference software of Versatile Video coding (VVC), the next generation video coding standard developed by the Joint Collaboration Team on Video Coding (JCT-VC) of ITU-T Video Coding Experts Group (VCEG) and ISO/IEC Motion Picture Experts Group (MPEG). One of ordinary skill in the art will understand that embodiments of the invention are not limited to HEVC or VVC but rather aimed at their next generations and/or any other codecs.

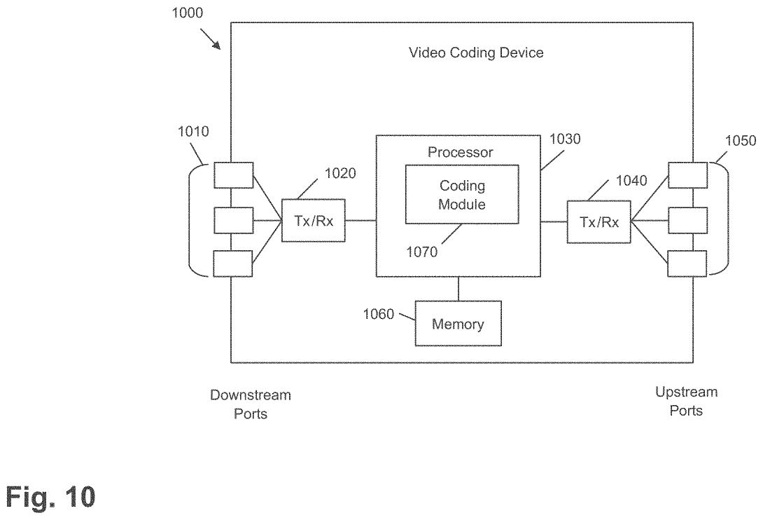

FIG. 10 is a schematic diagram of a video coding device 1000 according to an embodiment of the disclosure. The video coding device 1000 is suitable for implementing the disclosed embodiments as described herein. In an embodiment, the video coding device 1000 may be a decoder such as video decoder 30 of FIG. 8 or an encoder such as video encoder 20 of FIG. 8.

The video coding device 1000 comprises ingress ports 1010 (or input ports 1010) and receiver units (Rx) 1020 for receiving data; a processor, logic unit, or central processing unit (CPU) 1030 to process the data; transmitter units (Tx) 1040 and egress ports 1050 (or output ports 1050) for transmitting the data; and a memory 1060 for storing the data. The video coding device 1000 may also comprise optical-to-electrical (OE) components and electrical-to-optical (EO) components coupled to the ingress ports 1010, the receiver units 1020, the transmitter units 1040, and the egress ports 1050 for egress or ingress of optical or electrical signals.

The processor 1030 is implemented by hardware and software. The processor 1030 may be implemented as one or more CPU chips, cores (e.g., as a multi-core processor), FPGAs, ASICs, and DSPs. The processor 1030 is in communication with the ingress ports 1010, receiver units 1020, transmitter units 1040, egress ports 1050, and memory 1060. The processor 1030 comprises a coding module 1070. The coding module 1070 implements the disclosed embodiments described above. For instance, the coding module 1070 implements, processes, prepares, or provides the various coding operations. The inclusion of the coding module 1070 therefore provides a substantial improvement to the functionality of the video coding device 1000 and effects a transformation of the video coding device 1000 to a different state. Alternatively, the coding module 1070 is implemented as instructions stored in the memory 1060 and executed by the processor 1030.

The memory 1060 may comprise one or more disks, tape drives, and solid-state drives and may be used as an over-flow data storage device, to store programs when such programs are selected for execution, and to store instructions and data that are read during program execution. The memory 1060 may be, for example, volatile and/or non-volatile and may be a read-only memory (ROM), random access memory (RAM), ternary content-addressable memory (TCAM), and/or static random-access memory (SRAM).

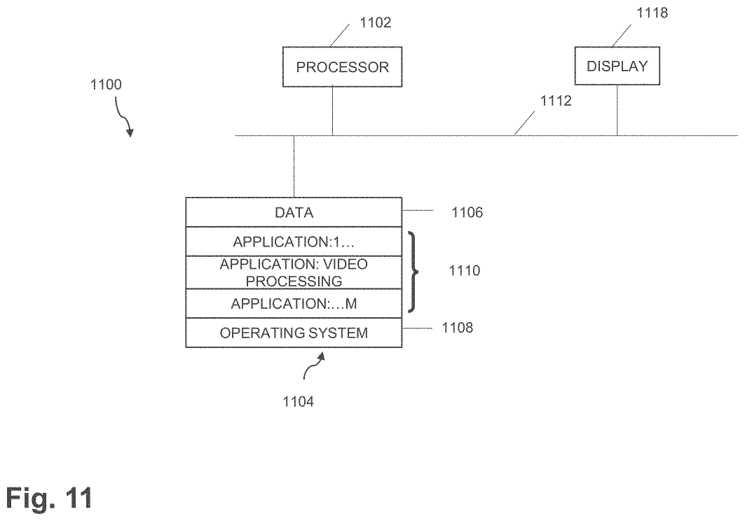

FIG. 11 is a simplified block diagram of an apparatus 800 that may be used as either or both of the source device 12 and the destination device 14 from FIG. 8 according to an exemplary embodiment.

A processor 1102 in the apparatus 1100 can be a central processing unit. Alternatively, the processor 1102 can be any other type of device, or multiple devices, capable of manipulating or processing information now-existing or hereafter developed. Although the disclosed implementations can be practiced with a single processor as shown, e.g., the processor 1102, advantages in speed and efficiency can be achieved using more than one processor.

A memory 1104 in the apparatus 1100 can be a read only memory (ROM) device or a random access memory (RAM) device in an implementation. Any other suitable type of storage device can be used as the memory 1104. The memory 1104 can include code and data 1106 that is accessed by the processor 1102 using a bus 1112. The memory 1104 can further include an operating system 1108 and application programs 1110, the application programs 1110 including at least one program that permits the processor 1102 to perform the methods described here. For example, the application programs 1110 can include applications 1 through N, which further include a video coding application that performs the methods described here.

The apparatus 1100 can also include one or more output devices, such as a display 1118. The display 1118 may be, in one example, a touch sensitive display that combines a display with a touch sensitive element that is operable to sense touch inputs. The display 1118 can be coupled to the processor 1102 via the bus 1112.

Although depicted here as a single bus, the bus 1112 of the apparatus 1100 can be composed of multiple buses. Further, a secondary storage can be directly coupled to the other components of the apparatus 1100 or can be accessed via a network and can comprise a single integrated unit such as a memory card or multiple units such as multiple memory cards. The apparatus 1100 can thus be implemented in a wide variety of configurations.

The present disclosure provides quantizer modification applicable to a quantizer side and quantizer modification applicable at a decoder side. It further includes the corresponding encoders, decoders, and the quantizers and inverse quantizers implemented therein. Some embodiments of the disclosure introduce a lightweight codec for compression of feature map and/or weights of neural network. It includes clipping, quantization, binarization and entropy-coding. The particular approach in some embodiments is modifying the quantizer or quantizer design process so that some of the quantizer levels are adjusted so that reconstructed feature maps span the full clipping range. This concept can be extended to define a set of fixed (non-modifiable) and non-fixed (modifiable) quantizer levels, where the fixed levels are not allowed to change during the quantizer design process, ensuring that important levels or reconstruction values are retained. A decoder-side modified inverse quantization adjustment process can also use the set of fixed and non-fixed quantizer levels, so that if a decoded reconstructed feature map value using the conventional quantizer is sufficiently close to one of the fixed quantizer levels, it can be adjusted to be equal to the closest fixed level. Additionally, instead of using entropy measured from a training set, the codeword lengths in bits is used during the rate-distortion optimized quantizer (or quantizer design) process.

A method for generating quantization levels for a quantizer whose inputs are data values may be implemented in/by the above mentioned hardware and/or software. The method may comprise defining an initial set of quantization levels, partitioning the initial set into fixed and non-fixed quantization level subsets, generating threshold values in the space spanned by the input data values in order to define a mapping from subsets of the input space to quantization levels; and adjusting the non-fixed quantization levels to minimize a distortion metric between the input data contained in each subset of the input space and its corresponding quantization level, while keeping the set of fixed quantization levels fixed.

The steps of generating threshold values and adjusting non-fixed quantization levels may be repeated until a distortion criterion is met. The fixed quantization level subset in some embodiments contains a minimum value, and the mapping maps data values that are less than the minimum value to the minimum value. For example, the fixed quantization level subset contains a maximum value, and the mapping maps data values that are greater than the maximum value to the maximum value. The input data values advantageously includes feature map output from a layer in a neural network. In addition or as an alternative, the input data values includes weight values in a neural network. In particular, the feature map values are the output of an activation process in a neural network.

According to an embodiment, a method is provided for decoding a bit stream, wherein the bit stream includes quantization indices, where each quantization index is mapped to a mapped original quantization level, wherein adjusted quantization levels are generated through the steps of defining a set of supplementary quantization levels; and computing adjustment distance metrics between each mapped original quantization level and elements in the set of supplementary quantization levels; and adjusting a mapped original quantization level to be equal to the supplementary quantization level that corresponds to the minimum distance metric, if the minimum adjustment distance metric is less than a threshold.

For example, the set of fixed final quantization levels is decoded from the bit stream. The set of fixed final quantization levels may include a minimum value, and the mapping maps data values that are less than the minimum value to the minimum value. In particular, the set of fixed final quantization levels includes a maximum value, and the mapping maps data values that are greater than the maximum value to the maximum value. For example, the quantization levels represent feature maps in a neural network and/or weight values in a neural network. The feature maps of an earlier layer in a neural network may be recovered from the reconstructed feature maps comprising reconstructed values. In some exemplary implementations, the activations are recovered from the reconstructed values obtained from a subset of the reconstructed maps tensors. A subset of activations may be recovered from the reconstructed values.

The parameters of the above described methods may be decoded from the bit stream. For example, the value lambda may decoded from the bit stream and is used in the distortion metric. The threshold may be decoded from the bit stream. The set of fixed final quantization levels are decoded from the bit stream.

Summarizing, the present disclosure relates to methods and apparatuses for modifying a quantizer. In particular, within a preliminary set of quantization levels, at least one quantization level is modified based on optimization involving distortion for a predetermined set of input values. At least one another quantization level out of the preliminary set is not modified. The not modified (non-modifiable) quantization level is the minimum clipping value or the maximum clipping value. The modification may facilitate increasing the dynamic range of the quantized/inverse-quantized data. Such modified quantizer may be advantageous for employment in neural networks to compress their data such as feature maps or the like. It may improve accuracy of the neural network.

1. A method for modifying quantization levels of a quantizer for a neural network, the method comprising the steps of:
obtaining data values and preliminary quantization levels attributed to the data values, the preliminary quantization levels including at least one non-modifiable quantization level and at least one modifiable quantization level;
determine modified quantization levels to include:
the at least one non-modifiable quantization level; and
at least one level obtained by adjusting the at least one modifiable quantization level based on a cost function indicative of a distortion between the obtained data values and the preliminary quantization levels,
wherein the at least one non-modifiable quantization level includes a minimum clipping value (cₘᵢₙ) to which all lower data values are clipped or a maximum clipping value (cₘₐₓ) to which all higher data values are clipped.

2. The method according to claim 1, wherein there are at least two non-modifiable quantization levels, including the minimum clipping value (cₘᵢₙ) and the maximum clipping value (cₘₐₓ).

3. The method according to claim 1, wherein there are at least two non-modifiable quantization levels, wherein among the at least two non-modifiable quantization levels, one has the value of zero.

4. The method according to claim 1, further comprising computing a level as a predefined function of the data values assigned to the level.

5. The method according to claim 1, wherein
the cost function includes a linear combination of the distortion and a rate,
the rate is represented by codeword length of codewords representing the respective preliminary quantization levels, and
the codewords representing at least two respective preliminary quantization levels having mutually different lengths.

6. The method according to claim 1, wherein
the steps of obtaining the preliminary quantization levels and determining the modified quantization levels are iterated K times, K being larger than 1,
a j-th iteration out of the K iterations comprises:
obtaining the preliminary quantization levels corresponding to the modified quantization levels determined by the (j−1)-th iteration,
determining the modified quantization levels to include the at least one non-modifiable quantization level and by modifying the at least one modifiable quantization level obtained by the (j−1)-the iteration based on the cost function.

7. The method according to claim 6, including stopping the iterations after the number of iterations K, in response to:
the value of the cost function in the K-th iteration being lower than a first threshold, or
the difference between the value of the cost function in the (K−1)-th iteration and the value of the cost function in the K-th iteration being lower than a second threshold.

8. The method according to claim 1, wherein the data values are:
values of a feature map output by a layer of the neural network, or
weights of a layer of the neural network.

9. The method according to claim 1, further comprising the steps of:
computing an adjustment distance between the modified quantization levels and the quantization levels before the modification,
adjusting the modified quantization levels by, for each modified quantization level, adopting either said modified quantization level or the quantization level before the modification, depending on the adjustment distance.

10. A method for decoding data for a neural network from a bitstream, the method including:
obtaining original quantization levels with which the data were quantized;
obtaining one or more supplementary quantization levels corresponding to a respective one or more of the original quantization levels,
computing an adjustment distance between the original quantization levels and the corresponding supplementary quantization levels,
determining modified quantization levels by, for each modified quantization level, adopting either an original quantization level or the corresponding supplementary quantization level, depending on the adjustment distance,
obtaining, from codewords of the bitstream, the data for the neural network based on the obtained modified quantization levels, and
process the obtained data for the neural network by at least one layer of the neural network.

11. The method according to claim 10, wherein the one or more supplementary quantization levels include at least one of a minimum clipping value to which all lower data values are clipped, a maximum clipping value to which all higher data values are clipped, or a zero value.

12. The method according to claim 10, wherein the adjustment distance includes a difference between the original and the corresponding supplementary quantization levels and an offset by a predetermined constant.

13. The method according to claim 10, wherein the determining of the modified quantization levels includes the following steps performed for each of the original quantization levels:
setting a modified quantization level corresponding to said original quantization level to the supplementary quantization level, when the adjustment distance is smaller than an adjustment threshold, or otherwise setting a modified quantization level to said original quantization level.

14. The method according to claim 10, further comprising decoding from the bitstream at least one of:
the predetermined constant,
the adjustment threshold, or
the supplementary levels.

15. A decoder for decoding data for a neural network from a bitstream, the decoder comprising:
quantization adjustment circuitry configured to obtain original quantization levels with which the data were quantized; obtain one or more supplementary quantization levels corresponding to a respective one or more of the original quantization levels; compute an adjustment distance between the original quantization levels and the corresponding supplementary quantization levels; and determine modified quantization levels by, for each modified quantization level, adopting either an original quantization level or the corresponding supplementary quantization level, depending on the adjustment distance,
inverse quantizer configured to obtain, from codewords of the bitstream, the data for the neural network based on the obtained modified quantization levels, and
neural network circuitry configured to process the obtained data for the neural network by at least one layer of the neural network.

16. The decoder according to claim 15, wherein the decoder is a cloud-based system.

17. The decoder according to claim 15, wherein the one or more supplementary quantization levels include at least one of a minimum clipping value to which all lower data values are clipped, a maximum clipping value to which all higher data values are clipped, or a zero value.

18. The decoder according to claim 15, wherein the adjustment distance includes a difference between the original and the corresponding supplementary quantization levels and an offset by a predetermined constant.

19. The decoder according to claim 15, wherein the quantization adjustment circuitry is configured to perform the following steps for each of the original quantization levels:
setting a modified quantization level corresponding to said original quantization level to the supplementary quantization level, when the adjustment distance is smaller than an adjustment threshold, or otherwise
setting a modified quantization level to said original quantization level.

20. The decoder according to claim 15, wherein the decoder is further configured to decode from the bitstream at least one of:
the predetermined constant,
the adjustment threshold, or
the supplementary levels
